(19) United States
(12) Patent Application Publication
(10) Pub. No.: US 2025/0053111 A1
(43) Pub. Date: Feb. 13, 2025

(54) LED PRINT DRIVE METHOD AND APPARATUS, LED PRINT DEVICE, AND STORAGE MEDIUM

(71) Applicant: HUAWEI TECHNOLOGIES CO., LTD., Shenzhen (CN)

(72) Inventors: Jiang Zhu, Dongguan (CN); Zhiwei Zheng, Osaka (JP); Kang Chung Liu, Shenzhen (CN)

(21) Appl. No.: 18/930,807

(22) Filed: Oct. 29, 2024

Related U.S. Application Data
(63) Continuation of application No. PCT/CN2023/090702, filed on Apr. 25, 2023.

(30) Foreign Application Priority Data
Apr. 29, 2022 (CN) 202210468989.3

(51) Int. Cl. G03G 15/04; H05B 45/10; H05B 47/155

(52) U.S. Cl. CPC G03G 15/04054; H05B 45/10; H05B 47/155; G03G 2215/0409

(57) ABSTRACT

An LED print drive method is applied to an LED array. The LED array includes a plurality of LED partitions, each LED partition includes one or more LED lights, and the plurality of LED partitions are distributed in a staggered manner based on a specified sequence. A print control unit generates a plurality of groups of data signals, and a drive control unit receives the plurality of groups of data signals from the print control unit. The drive control unit converts the plurality of groups of data signals into a plurality of groups of LED drive signals, and the drive control unit drives, in a time-sharing manner with the plurality of groups of LED drive signals, a corresponding LED partition to emit light. Light-emitting time of each LED partition corresponds to distribution of each LED partition.

### CROSS-REFERENCE TO RELATED APPLICATIONS

This application is a continuation of International Application No. PCT/CN2023/090702, filed on Apr. 25, 2023, which claims priority to Chinese Patent Application No. 202210468989.3, filed on Apr. 29, 2022. The disclosures of the aforementioned applications are hereby incorporated by reference in their entireties.

### TECHNICAL FIELD

This application relates to the field of printing technologies, and in particular, to a light-emitting diode (LED) print drive method and apparatus, an LED print device, and a storage medium.

### BACKGROUND

As one of output devices of a computer, a printer is configured to print a processing result of the computer on a related medium. With development of science and technology and improvement of people's living standards, the printer becomes an indispensable device in people's daily life. Daily printers may be classified into ink-jet printers, laser printers, and LED printers. The LED printer uses a group of light-emitting diodes to implement scanning photosensitive imaging. Specifically, a dense LED array is used as an optical transmitter, an electrical signal with data information is converted into an optical signal, and then the optical signal is transmitted to a photosensitive drum for imaging.

A conventional LED printer drives an LED array in a passive matrix (PM) mode, but the LED array of the LED printer is large in scale and requires a large quantity of driver chips.

In view of this, how to perform LED printing driving to reduce costs of LED printers is a problem that needs to be resolved at present.

### SUMMARY

This application provides an LED print drive method and apparatus, an LED print device, and a storage medium, to drive an LED printer and reduce costs of the LED printer.

According to a first aspect, an LED print drive method is provided. The method is applied to an LED array. The LED array includes a plurality of LED partitions, each LED partition includes one or more LED lights, and the plurality of LED partitions are distributed in a staggered manner based on a specified sequence. The method includes: obtaining a plurality of groups of data signals; converting the plurality of groups of data signals into a plurality of groups of LED drive signals; and driving, in a time-sharing manner with the plurality of groups of LED drive signals, a corresponding LED partition to emit light, where light-emitting time of each LED partition corresponds to distribution of each LED partition. In this aspect, the LED array is divided into the plurality of LED partitions, the plurality of LED partitions are distributed in the staggered manner based on the specified sequence, and different LED partitions are driven in a time-sharing manner to emit light, so that fewer driver chips are required, reducing LED printing costs.

In a possible implementation, the LED array is formed on a glass substrate. In this implementation, compared with a conventional silicon-based semiconductor process, a TFT process and a glass substrate technology are used to manufacture the LED array, which greatly reduces costs.

In another possible implementation, the plurality of LED partitions are sequentially distributed in a stepped shape or a wave shape.

In still another possible implementation, a distance between two adjacent LED partitions is a product of a print speed and a light-emitting time interval between the two LED partitions.

In yet another possible implementation, the LED array is formed on at least two glass substrates that are spliced with each other, the at least two glass substrates include a first glass substrate and a second glass substrate, the first glass substrate includes a plurality of first LED partitions, the second glass substrate includes a plurality of second LED partitions, and the plurality of first LED partitions and the plurality of second LED partitions are distributed in a stepped shape. The method further includes: dividing the plurality of groups of data signals into a plurality of groups of first data signals and a plurality of groups of second data signals; converting the plurality of groups of first data signals into a plurality of groups of first LED drive signals, and converting the plurality of groups of second data signals into a plurality of groups of second LED drive signals, where the plurality of groups of first LED drive signals and the plurality of groups of second LED drive signals include a plurality of pairs of LED drive signals of a same time sequence; driving a corresponding first LED partition in a time-sharing manner with the plurality of groups of first LED drive signals; and driving a corresponding second LED partition in a time-sharing manner with the plurality of groups of second LED drive signals. In this implementation, the LED array is formed on the spliced glass substrate. This improves a yield rate of the LED partition.

In still yet another possible implementation, at least one LED light on one of the at least two adjacent glass substrates overlaps with at least one LED light on another one of the at least two adjacent glass substrates, and the method further includes: performing, based on information about overlapped LED lights on the at least two glass substrates, seam-based adjustment on the at least one overlapped LED light on the at least two glass substrates. In this implementation, the seam-based adjustment is performed on at least one overlapped LED light based on the information about the overlapped LED lights, so that drive signals output to the plurality of LED partitions are not repeated.

In a further possible implementation, the LED array includes at least two groups of LED partitions, where the at least two groups of LED partitions include a first group of LED partitions and a second group of LED partitions, each group of LED partitions includes one or more LED partitions, each LED partition includes one or more LED lights, and the one or more LED partitions in each group of LED partitions are distributed in a stepped shape. The method further includes: dividing the plurality of groups of data signals into a plurality of groups of first data signals and a plurality of groups of second data signals, where the plurality of groups of first data signals and the plurality of groups of second data signals includes a plurality of pairs of data signals of a same time sequence; converting the plurality of groups of first data signals into a plurality of groups of first LED drive signals, and converting the plurality of groups of second data signals into a plurality of groups of second LED drive signals; driving one LED partition in the first group of LED partitions in a time-sharing manner with the plurality of groups of first LED drive signals; and driving one LED partition in the second group of LED partitions in a time-sharing manner with the plurality of groups of second LED drive signals. In this implementation, a plurality of driver chips are used drive in parallel. This improves a drive speed and is suitable for printing a large-sized image.

In a still further possible implementation, the LED array is formed on at least two glass substrates that are spliced with each other, the at least two glass substrates include a first glass substrate and a second glass substrate, the first glass substrate includes a plurality of first

LED partitions, the second glass substrate includes a plurality of second LED partitions, the plurality of first LED partitions and the plurality of second LED partitions are arranged in a straight line, and the plurality of first LED partitions and the plurality of second LED partitions are distributed in a stepped shape. The method further includes: dividing the plurality of groups of data signals into a plurality of groups of first data signals and a plurality of groups of second data signals, dividing the plurality of groups of first data signals into a first group of first data signals and a second group of first data signals, and dividing the plurality of groups of second data signals into a first group of second data signals and a second group of second data signals, where a time sequence of the first group of first data signals is the same as a time sequence of the second group of first data signals, a time sequence of the first group of second data signals is the same as a time sequence of the second group of second data signals, and time sequences of the plurality of groups of first data signals are different from time sequences of the plurality of groups of second data signals; converting the first group of first data signals into a first group of first LED drive signals, converting the second group of first data signals into a second group of first LED drive signals, converting the first group of second data signals into a first group of second LED drive signals, and converting the second group of second data signals into a second group of second LED drive signals; and driving a 1^{st} first LED partition on the first glass substrate with the first group of first LED drive signals, driving a 2^{nd} first LED partition on the first glass substrate with the second group of first LED drive signals, driving a 1^{st} first LED partition on the second glass substrate with the first group of second LED drive signals, and driving a 2^{nd} first LED partition on the second glass substrate with the second group of second LED drive signals. In this implementation, the LED array is formed on the spliced glass substrate. This improves a yield rate of the LED partition. In addition, a plurality of driver chips are used to drive in parallel. This improves a drive speed and is suitable for printing a large-sized image.

In a yet further possible implementation, the converting a plurality of groups of data signals into a plurality of groups of LED drive signals includes: converting the plurality of groups of data signals of a first quantity of bits into a plurality of groups of LED drive signals of a second quantity of bits, where the second quantity is greater than the first quantity. In this implementation, a drive control chip converts the plurality of groups of data signals of the first quantity of bits into the plurality of groups of LED drive signals of the second quantity of bits for output, so that quality of a printed image is clearer, and clarity of the printed image is better than that of an image printed by using a conventional halftone algorithm.

In a still yet further possible implementation, before the driving, in a time-sharing manner with the plurality of groups of LED drive signals, a corresponding LED partition to emit light, the method further includes: performing brightness uniformity compensation and/or light intensity compensation on the plurality of groups of LED drive signals. In this implementation, due to impact of an environment, a manufacturing process, and the like, brightness of a plurality of groups of LED drive signals obtained through processing may be uneven, and/or light-emitting intensity of LED lights may be uneven. The drive control chip performs brightness uniformity compensation on the plurality of groups of LED drive signals; and/or the drive control chip compensates for the impact of the temperature change on the light intensity of the LED light. This improves the brightness uniformity and light intensity uniformity of LED drive signal.

According to a second aspect, an LED print drive apparatus is provided, and can implement the method in the first aspect. The LED print drive apparatus may implement the foregoing method by using software or hardware, or by executing corresponding software by using hardware.

The apparatus is located in an LED print device, the LED print device further includes an LED array, the LED array includes a plurality of LED partitions, each LED partition includes one or more LED lights, and the plurality of LED partitions are distributed in a staggered manner based on a specified sequence. A print control unit is configured to: generate a plurality of groups of data signals, and output the plurality of groups of data signals to a drive control unit. The drive control unit is configured to convert the plurality of groups of data signals into a plurality of groups of LED drive signals. The drive control unit is further configured to drive, in a time-sharing manner with the plurality of groups of LED drive signals, a corresponding LED partition to emit light, where light-emitting time of each LED partition corresponds to distribution of each LED partition.

Optionally, the LED array is formed on a glass substrate.

Optionally, the plurality of LED partitions are sequentially distributed in a stepped shape or a wave shape.

Optionally, a distance between two adjacent LED partitions is a product of a print speed and a light-emitting time interval between the two LED partitions.

Optionally, the LED array is formed on at least two glass substrates that are spliced with each other, the at least two glass substrates include a first glass substrate and a second glass substrate, the first glass substrate includes a plurality of first LED partitions, the second glass substrate includes a plurality of second LED partitions, and the plurality of first LED partitions and the plurality of second LED partitions are distributed in a stepped shape. The apparatus further includes a bridge unit. The bridge unit is configured to: divide the plurality of groups of data signals into a plurality of groups of first data signals and a plurality of groups of second data signals, and output the plurality of groups of first data signals and the plurality of groups of second data signals to the drive control unit. The drive control unit is further configured to: convert the plurality of groups of first data signals into a plurality of groups of first LED drive signals, and convert the plurality of groups of second data signals into a plurality of groups of second LED drive signals, where the plurality of groups of first LED drive signals and the plurality of groups of second LED drive signals include a plurality of pairs of LED drive signals of a same time sequence. The drive control unit is further configured to drive a corresponding first LED partition in a time-sharing manner with the plurality of groups of first LED drive signals. The drive control unit is further configured to drive a corresponding second LED partition in a time-sharing manner with the plurality of groups of second LED drive signals.

Optionally, at least one LED light on one of the at least two adjacent glass substrates overlaps with at least one LED light on another one of the at least two adjacent glass substrates; and the bridge unit is further configured to perform, based on information about overlapped LED lights on the at least two glass substrates, seam-based adjustment on the at least one overlapped LED light on the at least two glass substrates.

Optionally, the LED array includes at least two groups of LED partitions, where the at least two groups of LED partitions include a first group of LED partitions and a second group of LED partitions, each group of LED partitions includes one or more LED partitions, each LED partition includes one or more LED lights, and the one or more LED partitions in each group of LED partitions are distributed in a stepped shape. The apparatus further includes a first time sequence control unit. The first time sequence control unit is configured to: divide the plurality of groups of data signals into a plurality of groups of first data signals and a plurality of groups of second data signals, and output the plurality of groups of first data signals and the plurality of groups of second data signals to the drive control unit, where the plurality of groups of first data signals and the plurality of groups of second data signals include a plurality of pairs of data signals of a same time sequence. The drive control unit is further configured to: convert the plurality of groups of first data signals into a plurality of groups of first LED drive signals, and convert the plurality of groups of second data signals into a plurality of groups of second LED drive signals. The drive control unit is further configured to drive one LED partition in the first group of LED partitions in a time-sharing manner with the plurality of groups of first LED drive signals. The drive control unit is further configured to drive one LED partition in the second group of LED partitions in a time-sharing manner with the plurality of groups of second LED drive signals.

Optionally, the LED array is formed on at least two glass substrates that are spliced with each other, the at least two glass substrates include a first glass substrate and a second glass substrate, the first glass substrate includes a plurality of first LED partitions, the second glass substrate includes a plurality of second LED partitions, the plurality of first LED partitions and the plurality of second LED partitions are arranged in a straight line, and the plurality of first LED partitions and the plurality of second LED partitions are distributed in a stepped shape. The apparatus further includes a second time sequence control unit. The second time sequence control unit is configured to: divide the plurality of groups of data signals into a plurality of groups of first data signals and a plurality of groups of second data signals, divide the plurality of groups of first data signals into a first group of first data signals and a second group of first data signals, divide the plurality of groups of second data signals into a first group of second data signals and a second group of second data signals, and output the first group of first data signals, the second group of first data signals, the first group of second data signals, and the second group of second data signals to the drive control unit, where a time sequence of the first group of first data signals is the same as a time sequence of the second group of first data signals, a time sequence of the first group of second data signals is the same as a time sequence of the second group of second data signals, and time sequences of the plurality of groups of first data signals are different from time sequences of the plurality of groups of second data signals. The drive control unit is further configured to: convert the first group of first data signals into a first group of first LED drive signals, convert the second group of first data signals into a second group of first LED drive signals, convert the first group of second data signals into a first group of second LED drive signals, and convert the second group of second data signals into a second group of second LED drive signals. The drive control unit is further configured to: drive a 1st first LED partition on the first glass substrate with the first group of first LED drive signals, drive a 2nd first LED partition on the first glass substrate with the second group of first LED drive signals, drive a 1st first LED partition on the second glass substrate with the first group of second LED drive signals, and drive a 2nd first LED partition on the second glass substrate with the second group of second LED drive signals.

Optionally, the drive control unit is further configured to convert a plurality of groups of data signals of a first quantity of bits into a plurality of groups of LED drive signals of a second quantity of bits, where the second quantity is greater than the first quantity. Optionally, the drive control unit is further configured to perform brightness uniformity compensation and/or light intensity compensation on the plurality of groups of LED drive signals.

According to a third aspect, an LED print device is provided, including an LED array and the LED print drive apparatus according to the second aspect or any one of the implementations of the second aspect, where the LED array includes a plurality of LED partitions, each LED partition includes one or more LED lights, and the plurality of LED partitions are distributed in a staggered manner based on a specified sequence.

In a possible implementation, the plurality of LED partitions are distributed in a stepped shape.

In another possible implementation, the LED array is formed on a glass substrate.

In still another possible implementation, a distance between two adjacent LED partitions is a product of a print speed and a light-emitting time interval between the two LED partitions.

In yet another possible implementation, the LED array is formed on at least two glass substrates that are spliced with each other, the at least two glass substrates include a first glass substrate and a second glass substrate, the first glass substrate includes a plurality of first LED partitions, the second glass substrate includes a plurality of second LED partitions, and the plurality of first LED partitions and the plurality of second LED partitions are distributed in a stepped shape.

In still yet another possible implementation, at least one LED light on one of the at least two adjacent glass substrates overlaps with at least one LED light on another one of the at least two adjacent glass substrates.

In a further possible implementation, the LED array includes at least two groups of LED partitions, where the at least two groups of LED partitions include a first group of LED partitions and a second group of LED partitions, each group of LED partitions includes one or more LED partitions, each LED partition includes one or more LED lights, and the one or more LED partitions in each group of LED partitions are distributed in a stepped shape.

In a still further possible implementation, the LED array is formed on at least two glass substrates that are spliced with each other, the at least two glass substrates include a first glass substrate and a second glass substrate, the first glass substrate includes a plurality of first LED partitions, the second glass substrate includes a plurality of second LED partitions, the plurality of first LED partitions and the plurality of second LED partitions are arranged in a straight line, and the plurality of first LED partitions and the plurality of second LED partitions are distributed in a stepped shape.

According to a fourth aspect, an LED print drive apparatus is provided, including: a processor, a memory, an input apparatus, and an output apparatus, where the memory stores instructions, and when the instructions are run by the processor, the apparatus is enabled to perform the method according to any one of the first aspect or the implementations of the first aspect.

According to a fifth aspect, this application provides a computer-readable storage medium. The storage medium stores a computer program or instructions, and when the computer program or the instructions are executed by a communication apparatus, the method according to any one of the first aspect or the implementations of the first aspect is implemented.

According to a sixth aspect, a computer program product is provided. When the computer program product is executed on a calculating device, the method according to any one of the first aspect or the implementations of the first aspect is performed.

### BRIEF DESCRIPTION OF DRAWINGS

FIG. 1 is a diagram of a hardware structure of a core part of an LED print device according to an embodiment of this application;

FIG. 2 is a diagram of a passive drive circuit according to an embodiment of this application;

FIG. 3 is a diagram of an active drive circuit according to an embodiment of this application;

FIG. 4 is a diagram of a structure of an LED print drive apparatus according to an embodiment of this application;

FIG. 5 is a schematic flowchart of an LED print drive method according to an embodiment of this application;

FIG. 6 is a diagram of an example of an LED partition driving time sequence according to an embodiment of this application;

FIG. 7a is a diagram of a structure of a drive control unit according to an embodiment of this application;

FIG. 7b is a diagram of another structure of a drive control unit according to an embodiment of this application;

FIG. 8 is a diagram of an internal module structure of a drive control unit according to an embodiment of this application;

FIG. 9 is a schematic flowchart of another LED print drive method according to an embodiment of this application;

FIG. 10 is a diagram of a structure of another LED print drive apparatus according to an embodiment of this application;

FIG. 11 is a schematic flowchart of still another LED print drive method according to an embodiment of this application;

FIG. 12 is a diagram of another example of an LED partition driving time sequence according to an embodiment of this application;

FIG. 13 is a diagram of a structure of still another LED print drive apparatus according to an embodiment of this application;

FIG. 14 is a schematic flowchart of yet another LED print drive method according to an embodiment of this application;

FIG. 15 is a diagram of an internal module structure of a time sequence control unit according to an embodiment of this application;

FIG. 16 is a diagram of a structure of yet another LED print drive apparatus according to an embodiment of this application;

FIG. 17 is a schematic flowchart of still yet another LED print drive method according to an embodiment of this application;

FIG. 18a is a diagram of a structure of a time sequence control unit according to an embodiment of this application;

FIG. 18b is a diagram of a structure of another time sequence control unit according to an embodiment of this application;

FIG. 19 is a diagram of a structure of still yet another LED print drive apparatus according to an embodiment of this application; and

FIG. 20 is a diagram of a structure of a further LED print drive apparatus according to an embodiment of this application.

### DESCRIPTION OF EMBODIMENTS

The following describes embodiments of this application with reference to accompanying drawings in embodiments of this application.

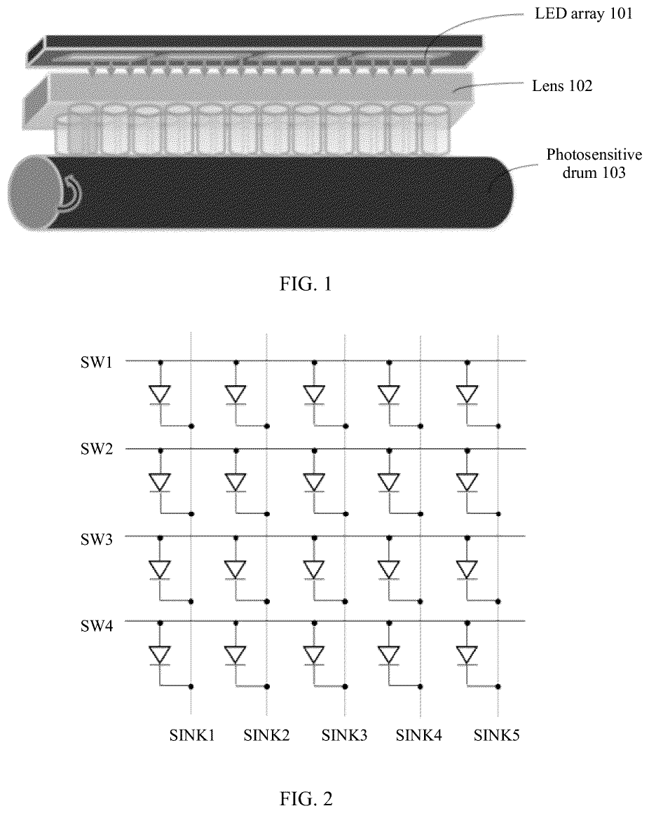

FIG. 1 is a diagram of a hardware structure of a core part of an LED print device according to an embodiment of this application. The core network part of the LED print device includes an LED array 101, a lens 102, and a photosensitive drum 103. The LED array 101 includes one or more LED lights. The lens 102 is configured to focus light. The LED print device uses a dense LED array 101 as an optical transmitter. The LED array 101 converts an electrical signal of data information into an optical signal, and then transmits the optical signal to the photosensitive drum 103 for imaging.

This application mainly relates to setting and driving for the LED array 101 in the LED print device.

The current LED drive technology is mainly applied to lighting, LCD backlight, LED direct display, and the like. There are two common LED drive technologies: passive drive and active (active matrix, AM) drive.

### (1) Passive Drive

Passive drive is also referred to as drive in a time-sharing manner. The passive drive simply forms a matrix with a cathode and an anode, and illuminates pixels in the array by scanning. Each pixel is operated in short pulse mode for instant light emitting with high brightness. FIG. 2 is a diagram of a passive drive circuit according to this embodiment of this application. The circuit includes five output channels (SINK1 to SINK5), and performs time-sharing driving (SW1 to SW4) for four times. A total of 20 LEDs or LED blocks can be driven.

The passive drive is characterized by simple drive circuit, printed circuit board (PCB) process, mature process and high stability. A drive current is large, and brightness of a single LED is high.

However, a passive drive mode is costly, and for a large-scale matrix LED array, a large quantity of driver chips are required if the passive drive mode is used. In the drive circuit shown in FIG. 2, it is assumed that one driver chip has five data output channels and four scan output channels, the driver chip can drive 20 LEDs in total. For an LED direct display array with a resolution of 3840×3×2160, a total of 1,240,000 driver chips are required. In addition, the passive drive mode is mainly used on the PCB substrate. For PCB processing precision, density of the LED array cannot be large. Therefore, the passive drive mode is commonly used in the field of LCD backlight and LED direct display with not-high pixels per inch (PPI).

### (2) Active Drive

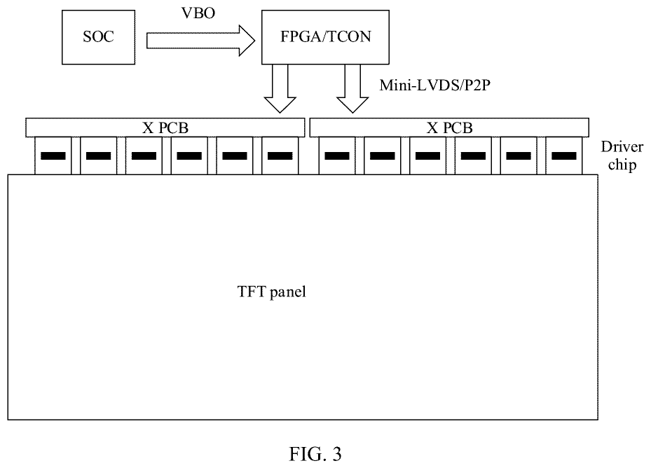

In active drive, each pixel is controlled by an independent thin film transistor (TFT). Each pixel can continuously and independently drive light emitting. Low-temperature polycrystalline silicon or oxide TFT can be used for driving. FIG. 3 is a diagram of an active drive circuit according to this embodiment of this application. The drive circuit includes a timing control chip (timing controller (TCON)/field-programmable gate array (FPGA)) and driver integrated circuits. The FPGA/TCON receives data signals from a system-on-chip (SOC) and outputs the signal to the driver chip. A row scanning control circuit (namely, a gate driven on array (GOA) circuit) turns on switches of a TFT panel row by row, and then a driver chip writes a corresponding data signal into a pixel of a corresponding row. The SOC and the FPGA/TCON transmit a data signal through a VBO (v-by-one) (a digital interface standard technology for image information transmission) interface. The FPGA/TCON communicates with the driver chip through a mini-LVDS/P2P interface.

The active drive circuit requires a small quantity of driver chips, and therefore has low costs. For example, for an LED direct display array with a resolution of 3840×3×2160, a total of 12 driver chips are required. The active drive circuit uses a TFT process and technology, and has high precision, and can drive an LED pixel array with a high PPI.

The glass substrate TFT technology is used in an active drive mode, so a drive current of a single LED cannot be too high.

It can be learned from the foregoing that the active drive mode has an obvious advantage over the passive drive mode.

As described above, the foregoing LED drive technology is mainly applied to fields of lighting, LCD backlight, LED direct display, and the like. Currently, there is no solution of driving an LED array of an LED printer in the active drive mode.

In view of this, this application provides an LED print drive solution. An LED array is divided into a plurality of LED partitions, the plurality of LED partitions are distributed in a staggered manner based on a specified sequence, and different LED partitions are driven, in a time-sharing manner, to emit light, so that fewer driver chips are required, reducing LED printing costs.

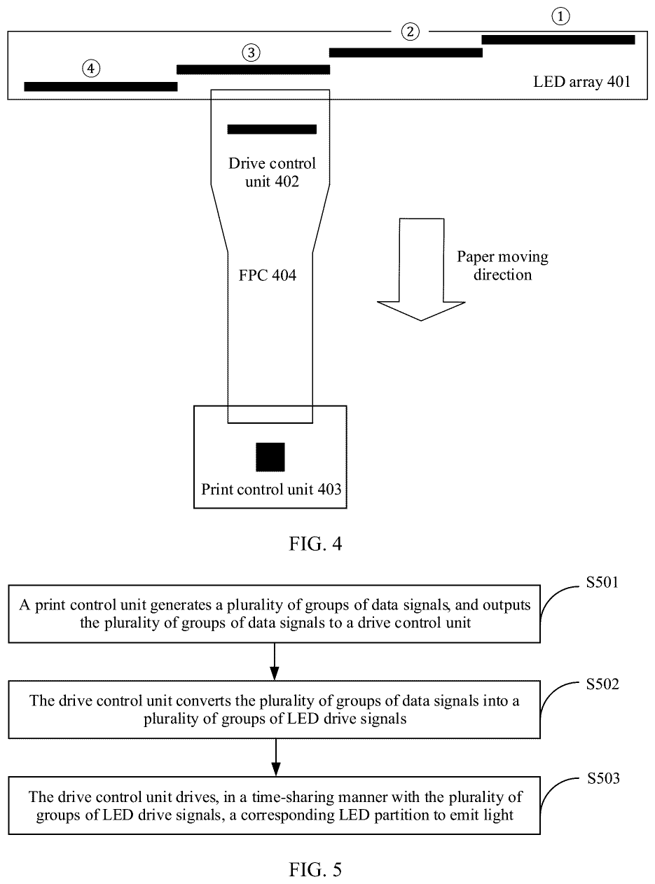

FIG. 4 is a diagram of a structure of an LED print device according to an embodiment of this application. The LED print device includes an LED array 401 and an LED print drive apparatus. The LED print drive apparatus includes a drive control unit 402 and a print control unit 403. The drive control unit 402 is separately connected to the print control unit 403 and the LED array 401. For example, the drive control unit 402 is connected to the print control unit 403 through a flexible printed circuit (FPC). The LED array 401 includes a plurality of LED partitions (in FIG. 4, a total of four LED partitions \textcircled{1} to \textcircled{4} are illustrated, and a quantity of LED partitions is not limited in embodiments). Each LED partition includes one or more LED lights. The plurality of LED partitions are distributed in a staggered manner based on a specified sequence. In an example, the plurality of LED partitions are distributed in a stepped shape (in FIG. 4, the LED array 401 is arranged into four steps), and the steps are parallel to each other. For example, LED lights corresponding to the steps are continuously distributed. In another example, the plurality of LED partitions may also be distributed in a wave shape. A specific distribution manner of the plurality of LED partitions is not limited in this application.

For example, the LED array 401 is formed on a glass substrate. Compared with a conventional silicon-based semiconductor process, a TFT process and a glass substrate technology in this embodiment are used to manufacture the LED array, which greatly reduces costs. A TFT device may be manufactured on the glass substrate by etching and coating.

Based on the LED print device shown in FIG. 4, as shown in FIG. 5, an embodiment of this application further provides an LED print drive method. For example, the method may include the following steps.

S501: A print control unit generates a plurality of groups of data signals, and outputs the plurality of groups of data signals to a drive control unit.

The print control unit may be a central control unit in an LED printer, and is configured to output a data signal. As shown in FIG. 4, because the LED array includes a plurality of LED partitions, the print control unit outputs a plurality of groups of data signals to the drive control unit, and each group of data signals corresponds to one LED partition.

For example, the data signal output by the print control unit may be a low-voltage differential signal (LVDS).

S502: The drive control unit converts the plurality of groups of data signals into a plurality of groups of LED drive signals.

After receiving the plurality of groups of data signals from the print control unit, the drive control unit may respectively convert the plurality of groups of data signals into the plurality of groups of LED drive signals by using the conventional technology. The LED drive signal includes an analog signal for controlling an LED light-emitting unit to be bright or dark and a scanning signal for driving an LED light-emitting step. The LED drive signal is used to drive the LED light in the LED partition to emit light.

S503: The drive control unit drives, in a time-sharing manner with the plurality of groups of LED drive signals, a corresponding LED partition to emit light.

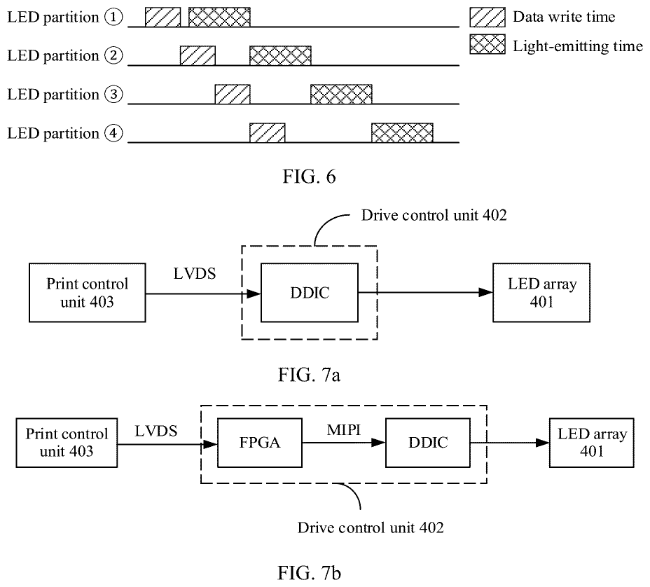

In this embodiment, the plurality of LED partitions are set to be distributed in a stepped shape, and light-emitting time of all LED partitions is different. In this case, FIG. 6 is a diagram of an example of an LED partition driving time sequence according to an embodiment of this application. Time at which a drive control unit writes data to each LED partition is different. In the example shown in FIG. 6, the drive control unit sequentially writes drive signals to an LED partition \textcircled{1} to an LED partition \textcircled{4} for four times, to drive the LED partition \textcircled{1} to the LED partition \textcircled{4} to emit light sequentially (at four different light-emitting time). For example, the time when the drive control unit writes the drive signals to the LED partition [symbol] to the LED partition [symbol] is in a stepped shape, so that the light-emitting time of each LED partition corresponds to a step in which each LED partition is located, and the light-emitting time of the LED partition [symbol] to the LED partition [symbol] is also in a stepped shape. A light-emitting sequence of the four LED partitions is consistent with a paper moving direction shown in FIG. 6.

The LED array 401 shown in FIG. 4 is driven and controlled to emit light, so that printing of a row on a printing medium can be implemented. It is assumed that the LED array includes n LED partitions, 1/n-row printing is implemented in each LED partition. As shown in FIG. 4, the LED array 401 includes the LED partition [symbol] to the LED partition [symbol] , and ¼-row printing is implemented in each LED partition. A distance between two adjacent LED partitions that are parallel to each other is a product of the print speed and a light-emitting time interval between the two LED partitions.

In this embodiment, the LED array is formed on the glass substrate. Therefore, the LED array is driven, in an active drive mode, to emit light, so that fewer driver chips are required, reducing costs of the LED printer. In addition, because the LED array includes a plurality of LED partitions, and light emitting of the plurality of LED partitions is controlled in a time-sharing manner, a requirement for a driver chip is further reduced, and costs of an LED printer is further reduced.

The drive control unit in this embodiment includes functions of time sequence control and driving light emitting. FIG. 7a is a diagram of a structure of a drive control unit according to an embodiment of this application. The drive control unit may be a display driver chip (DDIC) newly defined in this embodiment. The DDIC has functions of time sequence control and driving light emitting. The DDIC receives a plurality of groups of LVDS signals output by the print control unit 403. The DDIC converts the plurality of groups of LVDS signals into a plurality of groups of LED drive signals, and outputs, in a time-sharing manner, the plurality of groups of LED drive signals to the plurality of LED partitions in the LED array 401.

FIG. 7b is a diagram of another structure of a drive control unit according to an embodiment of this application. The drive control unit includes an existing DDIC and an FPGA. The FPGA is used to implement a time sequence control function. The FPGA can also be replaced with a TCON. The FPGA receives a plurality of groups of LVDS signals output by the existing print control unit 403, and the FPGA determines a time sequence of the plurality of groups of LVDS signals. The DDIC is configured to convert the plurality of groups of LVDS signals whose time sequences are determined into a plurality of groups of LED drive signals of the corresponding time sequences. The DDIC outputs, in a time-sharing manner, the plurality of groups of LED drive signals to the plurality of LED partitions in the LED array 401.

According to an LED print drive method provided in this embodiment of this application, an LED array is divided into a plurality of LED partitions, the plurality of LED partitions are distributed in a staggered manner based on a specified sequence, and different LED partitions are driven, in a time-sharing manner, to emit light, so that fewer driver chips are required, reducing LED printing costs.

Compared with a conventional silicon-based semiconductor process, a TFT process and a glass substrate technology are used to manufacture the LED array, which greatly reduces costs.

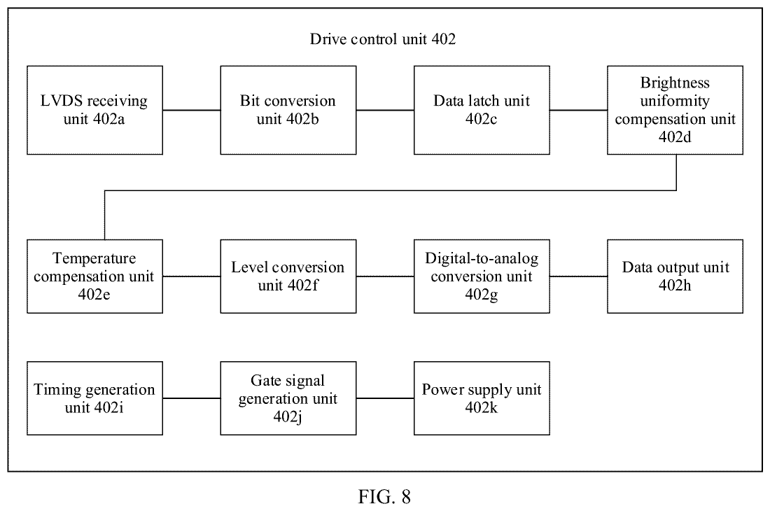

FIG. 8 is a diagram of a detailed internal structure of a drive control unit according to an embodiment of this application. The drive control unit 402 includes a time sequence control function and a data processing function. The data processing function includes one or more of the following subunits: an LVDS receiving unit (LVDS Rx unit) 402a, a bit conversion unit 402b, a data latch unit 402c, a brightness uniformity compensation unit (DEMURA unit) 402d, a temperature compensation unit 402e, a level conversion unit 402f, a digital-to-analog conversion unit (DAC unit) 402g, and a source output unit 402h. The time sequence control function includes one or more of the following subunits: a timing generation unit 402i, a gate output generation unit 402j, and power unit 402k.

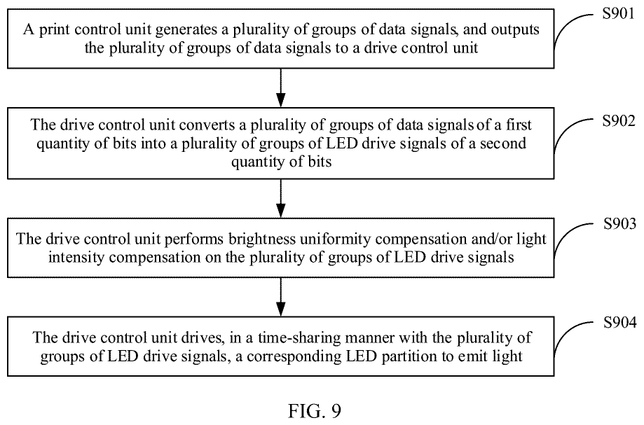

The following describes in detail functions of the foregoing units with reference to another LED print drive method provided in an embodiment of this application shown in FIG. 9. For example, the method may include the following steps.

S901: A print control unit generates a plurality of groups of data signals, and outputs the plurality of groups of data signals to a drive control unit.

In this embodiment, the print control unit outputs the plurality of groups of data signals. Each group of data signals are data signals of a first quantity of bits. For example, the first quantity of bits is 1 bit. The data signals may be LVDS signals.

For example, an LVDS receiving unit 402a in the drive control unit receives a plurality of groups of 1-bit LVDS signals output by the print control unit.

S902: The drive control unit converts a plurality of groups of data signals of the first quantity of bits into a plurality of groups of LED drive signals of a second quantity of bits. Conventional LED printers use 1-bit light-emitting precision (on or off) for LED partitions and use a halftone algorithm to achieve multi-bit display effect (that is, divide the light-on and off into a plurality of levels to compensate for uneven brightness of LED lights), so that quality of a printed image is not clear enough.

In this embodiment, a bit quantity conversion unit 402b in the drive control unit converts LVDS signals of 1 bit or few bits in each group of LVDS signals into data signals of the second quantity of bits. For example, the second quantity of bits are 8 bits.

In an implementation, the drive control unit may be the DDIC in FIG. 7a, and a bit conversion unit 402b in the DDIC converts the LVDS signals of 1 bit or few bits in each group of LVDS signals into data signals of the second quantity of bits.

In another implementation, the drive control unit may include the FPGA and the DDIC in FIG. 7b. The bit conversion function may be implemented in the FPGA. That is, a control chip (the FPGA/TCON) is connected at the front end of the driver chip DDIC, and converts a 1-bit LVDS signal in each group of data signals into an 8-bit MIPI signal. The driver chip DDIC receives an 8-bit MIPI signal, and converts the 8-bit MIPI signal into a drive signal required for driving the LED light-emitting element array. The drive signal includes an analog signal for controlling an LED light-emitting unit to be bright or dark and a scanning signal for driving an LED light-emitting step.

8-bit data signals may be used to represent 256 different levels of black and white. Therefore, through the foregoing conversion, quality of a printed image can be finer, and fineness of the printed image is better than that of an image printed by using a conventional halftone algorithm.

Further, a data latch unit 402c in the drive control unit latches the plurality of groups of data signals of the second quantity of bits that are obtained, by using the bit conversion unit 402b, through conversion. The data latch unit 402c may further perform serial-to-parallel conversion on the data signals of the plurality of groups of the second quantity of bits.

S903: The drive control unit performs brightness uniformity compensation and/or light intensity compensation on the plurality of groups of LED drive signals.

Due to impact of an environment, a manufacturing process, and the like, the plurality of groups of LED drive signals obtained through processing in step S902 may be uneven, and/or light-emitting intensity of the LED lights may be uneven.

A brightness uniformity compensation unit 402d in the drive control unit may perform brightness uniformity compensation on the plurality of groups of LED drive signals; and/or a temperature compensation unit 402e in the drive control unit may compensate for the impact of the temperature change on the light intensity of the LED light.

Further, a level conversion unit 402f converts a plurality of groups of compensated LED drive signals from a digital signal into a high-voltage electrical signal for driving the digital-to-analog conversion unit 402g.

Further, a digital-to-analog conversion unit 402g converts the plurality of groups of processed LED drive signals (digital gray-scale signals) into analog signals corresponding to gray-scale voltages.

Further, a timing generation unit 402i generates a time sequence signal for driving an LED array.

Further, a gate output generation unit 402j generates scanning signals for driving different rows.

Further, a power unit 402k supplies power to another unit in a drive control unit 402.

S904: The drive control unit drives, in a time-sharing manner with the plurality of groups of LED drive signals, a corresponding LED partition to emit light.

A source output unit 402h outputs the time sequence signal generated by the timing generation unit 402i and the scanning signal generated by the gate output generation unit 402j. Therefore, according to the time sequence signal, the corresponding LED partition are driven, in a time-sharing manner with the scanning signal, to emit light. For a specific implementation process, refer to step S503. Details are not described herein again.

According to an LED print drive method provided in this embodiment of this application, an LED array is divided into a plurality of LED partitions, the plurality of LED partitions are distributed in a staggered manner based on a specified sequence, and different LED partitions are driven, in a time-sharing manner, to emit light, so that fewer driver chips are required, reducing LED printing costs.

Compared with a case in which a conventional LED printer uses a first quantity of bits (1 bit or a few bits) for output, in this embodiment, the drive control unit converts the plurality of groups of data signals of the first quantity of bits into the plurality of groups of LED drive signals of the second quantity of bits for output, so that quality of a printed image is finer, and fineness of the printed image is better than that of an image printed by using a conventional halftone algorithm.

In this embodiment, the drive control unit is compatible with brightness uniformity compensation and/or light intensity compensation. This improves printing effect.

Compared with a conventional silicon-based semiconductor process, a TFT process and a glass substrate technology are used to manufacture the LED array, which greatly reduces costs.

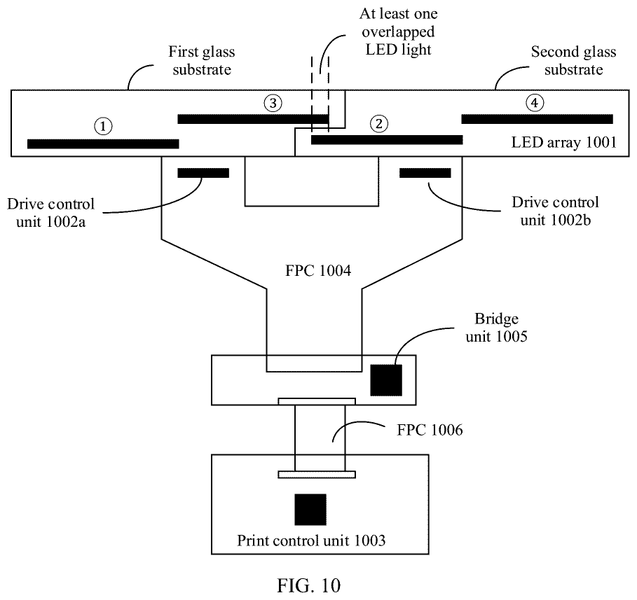

FIG. 10 is a diagram of a structure of another LED print device according to an embodiment of this application. The LED print device includes: an LED array 1001 and an LED drive apparatus, where the LED drive apparatus includes a drive control unit 1002a, a drive control unit 1002b, and a print control unit 1003. The LED array 1001 includes a plurality of LED partitions (in FIG. 10, a total of four LED partitions [symbol] to [symbol] are illustrated, and a quantity of LED partitions is not limited in embodiments). Each LED partition includes one or more LED lights. The LED array 1001 is formed on a glass substrate, the glass substrate is in a long strip shape, and the glass substrate in the long strip shape is formed by splicing at least two glass substrates. In FIG. 10, the at least two glass substrates include a first glass substrate and a second glass substrate. The first glass substrate includes a plurality of first LED partitions (in FIG. 10, including the LED partition [symbol] and the LED partition [symbol] ), and the second glass substrate includes a plurality of second LED partitions (in FIG. 10, including the LED partition [symbol] and the LED partition [symbol] ). The plurality of first LED partitions and the plurality of second LED partitions are distributed in a staggered manner based on a specified sequence. For example, the plurality of first LED partitions and the plurality of second LED partitions are distributed in a stepped shape, and steps are parallel to each other. For example, the LED partition [symbol] and the LED partition [symbol] are distributed in a stepped shape, and the LED partition [symbol] and the LED partition [symbol] are distributed in a stepped shape. At least one LED light on one of the adjacent glass substrates overlaps with at least one LED light on another one of the adjacent glass substrates.

The drive control unit 1002a is configured to drive the plurality of first LED partitions on the first glass substrate, for example, to drive the LED partition [symbol] and the LED partition [symbol] . The drive control unit 1002b is configured to drive the plurality of second LED partitions on the second glass substrate, for example, to drive the LED partition [symbol] and the LED partition [symbol] .

The drive control unit 1002a and the drive control unit 1002b are connected to the print control unit 1003 through an FPC 1004, a bridge unit 1005, and an FPC 1006.

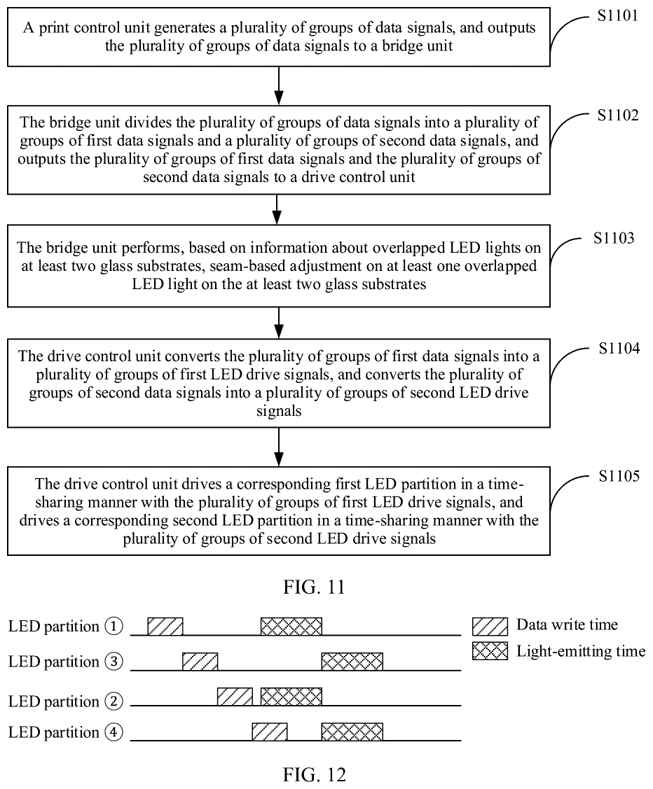

Based on the LED print device in FIG. 10, as shown in FIG. 11, an embodiment of this application further provides still another LED print drive method. For example, the method may include the following steps.

S1101: A print control unit generates a plurality of groups of data signals, and outputs the plurality of groups of data signals to a bridge unit.

As shown in FIG. 10, because the LED array includes a plurality of LED partitions, the print control unit outputs a plurality of groups of data signals to the bridge unit, and each group of data signals corresponds to one LED partition.

For example, a data signal output by the print control unit may be an LVDS signal.

For example, the bridge unit may be a unit independent of a drive control unit, or may be a unit in a drive control unit.

S1102: The bridge unit divides the plurality of groups of data signals into a plurality of groups of first data signals and a plurality of groups of second data signals, and outputs the plurality of groups of first data signals and the plurality of groups of second data signals to the drive control unit.

As shown in FIG. 10, in this embodiment, the LED array is formed on at least two glass substrates that are spliced with each other, and at least one LED light on one of the adjacent glass substrates overlaps with at least one LED light on another one of the adjacent glass substrates.

For same yield rates, one LED array may have N defective pixels. If the LED array is formed on M spliced glass substrates, each glass substrate has only N/M defective pixels, and a probability that each small LED partition has no defective pixel is greatly increased.

After receiving the plurality of groups of data signals from the print control unit, the bridge unit may first buffer the plurality of groups of data signals.

Then, because the LED array is formed on at least two glass substrates that are spliced with each other, LED lights on each glass substrate are driven by one drive control unit. As shown in FIG. 10, the drive control unit 1002a is configured to drive the plurality of first LED partitions on the first glass substrate, for example, to drive the LED partition [symbol] and the LED partition [symbol] . The drive control unit 1002b is configured to drive the plurality of second LED partitions on the second glass substrate, for example, to drive the LED partition [symbol] and the LED partition [symbol] . Therefore, the bridge unit divides the plurality of groups of data signals into the plurality of groups of first data signals and the plurality of groups of second data signals, outputs the plurality of groups of first data signals to the drive control unit 1002a, and outputs the plurality of groups of second data signals to the drive control unit 1002b.

S1103: The bridge unit performs, based on information about overlapped LED lights on the at least two glass substrates, seam-based adjustment on the at least one overlapped LED light on the at least two glass substrates.

As shown in FIG. 10, the first glass substrate and the second glass substrate overlap each other, and at least one overlapped LED light exists between the LED partition [symbol] on the first glass substrate and the LED partition [symbol] on the second glass substrate. The information about the overlapped LED lights may be obtained when the LED array is manufactured. For example, the information includes a quantity of overlapped LED lights. Because at least one LED light on one of the two adjacent glass substrates overlaps with at least one LED light on the other of the two adjacent glass substrates, as shown in FIG. 10, the LED array 1001 includes the LED partition [symbol] to the LED partition [symbol] , and ¼-row printing is implemented in each LED partition. The bridge unit needs to perform seam-based adjustment on the at least one overlapped LED light based on the information about the overlapped LED light, so that drive signals output to the LED partition [symbol] and the LED partition [symbol] are not repeated.

S1104: The drive control unit converts the plurality of groups of first data signals into a plurality of groups of first LED drive signals, and converts the plurality of groups of second data signals into a plurality of groups of second LED drive signals.

As shown in FIG. 10, after receiving the plurality of groups of first data signals output by the bridge unit 1005, the drive control unit 1002a converts the plurality of groups of first data signals into the plurality of groups of first LED drive signals. The drive control unit 1002a may convert the plurality of groups of first data signals into the plurality of groups of first LED drive signals respectively by using the conventional technology.

After receiving the plurality of groups of second data signals output by the bridge unit 1005, the drive control unit 1002b converts the plurality of groups of second data signals into the plurality of groups of second LED drive signals. The drive control unit 1002b may also convert the plurality of groups of second data signals into the plurality of groups of second LED drive signals respectively by using the conventional technology.

The LED drive signal includes an analog signal for controlling an LED light-emitting unit to be bright or dark and a scanning signal for driving an LED light-emitting step. The LED drive signal is used to drive the LED light in the LED partition to emit light.

The plurality of groups of first LED drive signals and the plurality of groups of second LED drive signals include a plurality of pairs of LED drive signals of a same time sequence. As shown in FIG. 10, a time sequence of the LED partition [symbol] on the first glass substrate is the same as that of the LED partition [symbol] on the second glass substrate, and a time sequence of the LED partition [symbol] on the first glass substrate is the same as that of the LED partition [symbol] on the second glass substrate.

S1105: The drive control unit drives a corresponding first LED partition in a time-sharing manner with the plurality of groups of first LED drive signals, and drives a corresponding second LED partition in a time-sharing manner with the plurality of groups of second LED drive signals.

After obtaining the plurality of groups of first LED drive signals, the drive control unit 1002a drives, in a time-sharing manner, the LED partition [symbol] and the LED partition [symbol] on the first glass substrate to emit light. After obtaining the plurality of groups of second LED drive signals, the drive control unit 1002b drives, in a time-sharing manner, the LED partition [symbol] and the LED partition [symbol] on the second glass substrate to emit light.

The drive control unit 1002a and the drive control unit 1002b may use the structure of the drive control unit shown in FIG. 7a or FIG. 7b.

FIG. 12 is a diagram of another LED partition driving time sequence according to an embodiment of this application. Time at which a drive control unit 1002a writes data to each LED partition on a first glass substrate is different, and time at which a drive control unit 1002b writes data to each LED partition on a second glass substrate is also different. In the example shown in FIG. 12, the drive control unit 1002a sequentially writes drive signals to an LED partition [symbol] and an LED partition [symbol] twice, to drive the LED partition [symbol] and the LED partition [symbol] to emit light sequentially (at different light-emitting time twice); and the drive control unit 1002b sequentially writes drive signals to an LED partition [symbol] and an LED partition [symbol] twice, to drive the LED partition [symbol] and the LED partition [symbol] to emit light sequentially. In addition, light-emitting time of the LED partition [symbol] on the first glass substrate is controlled to be the same as light-emitting time of the LED partition [symbol] on the second glass substrate, and light-emitting time of the LED partition [symbol] on the first glass substrate is controlled to be the same as light-emitting time of the LED partition [symbol] on the second glass substrate.

According to an LED print drive method provided in this embodiment of this application, an LED array is divided into a plurality of LED partitions, the plurality of LED partitions are distributed in a staggered manner based on a specified sequence, and different LED partitions are driven, in a time-sharing manner, to emit light, so that fewer driver chips are required, reducing LED printing costs.

Compared with a conventional silicon-based semiconductor process, a TFT process and a glass substrate technology are used to manufacture the LED array, which greatly reduces costs.

The LED array is formed on the spliced glass substrate. This improves a yield rate of the LED partition.

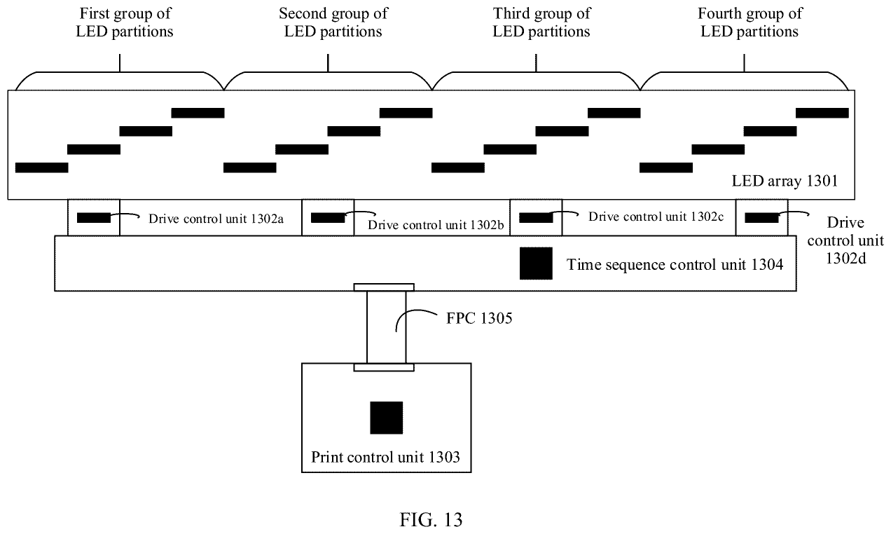

FIG. 13 shows still another LED print device according to an embodiment of this application. The LED print device includes an LED array 1301 and an LED drive apparatus, where the LED drive apparatus includes a drive control unit 1302a to a drive control unit 1302d, a print control unit 1303, and a time sequence control unit 1304. For example, one end of each of the drive control unit 1302a to the drive control unit 1302d may be connected to a glass substrate, and the other end may be connected to a PCB. The time sequence control unit 1304 is located on the PCB. The LED array 1301 includes at least two groups of LED partitions (four groups of LED partitions are shown in the figure: a first group of LED partitions to a fourth group of LED partitions. A quantity of groups of LED partitions is not limited in this application, and is only an example herein). Each group of LED partitions includes one or more LED partitions, and each LED partition includes one or more LED lights. The one or more LED partitions in each group of LED partitions are distributed in a staggered manner based on a specified sequence. For example, the one or more LED partitions in each group of LED partitions are distributed in a stepped shape, and steps are parallel to each other. As shown in FIG. 13, four LED partitions in the first group of LED partitions are distributed in a stepped shape, four LED partitions in a second group of LED partitions are distributed in a stepped shape, four LED partitions in a third group of LED partitions are distributed in a stepped shape, and four LED partitions in the fourth group of LED partitions are distributed in a stepped shape.

Each group of LED partitions is driven by a drive control unit. As shown in FIG. 13, the drive control unit 1302a is configured to drive the first group of LED partitions, a drive control unit 1302b is configured to drive the second group of LED partitions, a drive control unit 1302c is configured to drive the third group of LED partitions, and the drive control unit 1302d is configured to drive the fourth group of LED partitions. The drive control unit 1302a to the drive control unit 1302d are connected to the time sequence control unit 1304. The time sequence control unit 1304 is connected to the print control unit 1303 through an FPC 1305.

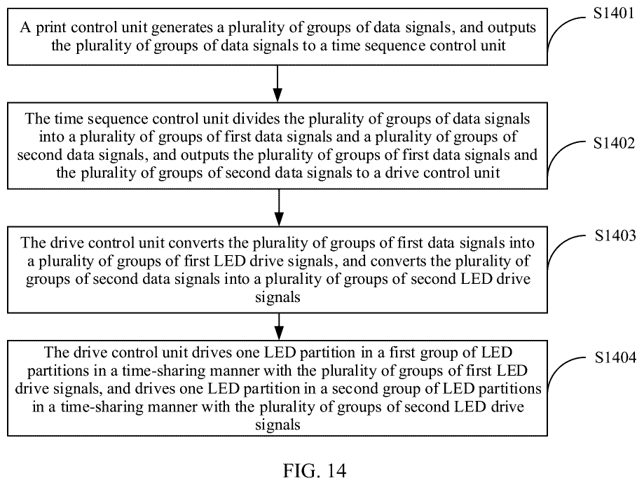

Based on the LED print device shown in FIG. 13, as shown in FIG. 14, this application further provides yet another LED print drive method. For example, the method may include the following steps.

S1401: A print control unit generates a plurality of groups of data signals, and outputs the plurality of groups of data signals to a time sequence control unit.

As shown in FIG. 13, because the LED array includes the at least two groups of LED partitions, the print control unit outputs a plurality of groups of data signals to the time sequence control unit, and each group of data signals corresponds to one group of LED partitions.

For example, a data signal output by the print control unit may be an LVDS signal.

S1402: The time sequence control unit divides the plurality of groups of data signals into a plurality of groups of first data signals and a plurality of groups of second data signals, and outputs the plurality of groups of first data signals and the plurality of groups of second data signals to a drive control unit.

Each group of LED partitions includes one or more LED partitions. The one or more LED partitions in each group of LED partitions are distributed in a stepped shape. When the LED array includes the at least two groups of LED partitions, the time sequence control unit divides the plurality of groups of data signals into the plurality of groups of first data signals and the plurality of groups of second data signals.

In addition, because the plurality of groups of LED partitions include a plurality of LED partitions with same step distribution, the plurality of groups of first data signals and the plurality of groups of second data signals include a plurality of pairs of data signals of a same time sequence. Each pair of data signals corresponds to at least two LED partitions with same step distribution.

As shown in FIG. 13, the LED array includes four groups of LED partitions, and the time sequence control unit divides a plurality of groups of data signals into a plurality of groups of first data signals, a plurality of groups of second data signals, a plurality of groups of third data signals, and a plurality of groups of fourth data signals. The time sequence control unit 1304 outputs the plurality of groups of first data signals to the drive control unit 1302a, outputs the plurality of groups of second data signals to the drive control unit 1302b, outputs the plurality of groups of third data signals to the drive control unit 1302c, and outputs the plurality of groups of fourth data signals to the drive control unit 1302d.

Further, after receiving the plurality of groups of data signals from the print control unit, the time sequence control unit may further convert a plurality of groups of data signals of a first quantity of bits into a plurality of groups of data signals of a second quantity of bits, latch the plurality of groups of data signals of the second quantity of bits that are obtained through conversion, perform serial-to-parallel conversion, and perform brightness uniformity compensation and/or temperature compensation on the plurality of groups of data signals.

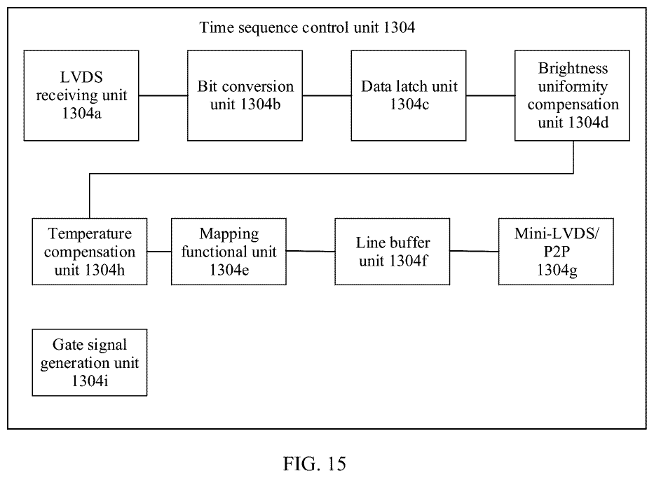

FIG. 15 is a diagram of an internal structure of a time sequence control unit according to this embodiment of this application. The time sequence control unit 1304 includes a data processing function and a time sequence control function. The data processing function includes one or more of the following subunits: an LVDS receiving unit (LVDS Rx unit) 1304a, a bit conversion unit 1304b, a data latch unit 1304c, a brightness uniformity compensation unit (DEMURA unit) 1304d, a mapping functional unit 1304e, a line buffer unit 1304f, mini-LVDS/P2P 1304g, and a temperature compensation unit 1304h. The time sequence control function includes the following subunit: timing generation unit 1304i. A difference between this embodiment and the embodiments shown in FIG. 8 and FIG. 9 lies in that, this embodiment is applicable to printing for a large-sized image, and each group of LED partitions is driven by a drive control unit. Therefore, the time sequence control unit 1304 in this embodiment implements a data processing function, for example, bit conversion, data latching, serial-to-parallel conversion, brightness uniformity compensation, temperature compensation, mapping, or line buffer, and a time sequence control function. The time sequence control unit 1304 may be implemented by using an FPGA chip/a TCON chip. The drive control unit 1302a to the drive control unit 1302d only implement a function of generating a drive signal, and may use an existing drive control chip, without changing an internal function and a structure of the drive control chip. For functions of the subunits in the time sequence control unit that are the same as the subunits in the drive control unit in FIG. 8, refer to the descriptions in the embodiments shown in FIG. 8 and FIG. 9. In addition, the time sequence control unit 1304 further includes a mapping functional unit 1304e, and the mapping functional unit 1304e maps a gray-scale data signal, to implement good printing effect. The time sequence control unit 1304 outputs the plurality of groups of first data signals and the plurality of groups of second data signals to the drive control unit through a mini-LVDS/P2P 1304g interface.

S1403: The drive control unit converts the plurality of groups of first data signals into a plurality of groups of first LED drive signals, and converts the plurality of groups of second data signals into a plurality of groups of second LED drive signals.

For example, as shown in FIG. 13, after receiving the plurality of groups of first data signals output by the time sequence control unit 1304, the drive control unit 1302a converts the plurality of groups of first data signals into a plurality of groups of first LED drive signals; after receiving the plurality of groups of second data signals output by the time sequence control unit 1304, the drive control unit 1302b converts the plurality of groups of second data signals into a plurality of groups of second LED drive signals; after receiving the plurality of groups of third data signals output by the time sequence control unit 1304, the drive control unit 1302c converts the plurality of groups of third data signals into a plurality of groups of third LED drive signals; and after receiving the plurality of groups of fourth data signals output by the time sequence control unit 1304, the drive control unit 1302d converts the plurality of groups of fourth data signals into a plurality of groups of fourth LED drive signals.

S1404: The drive control unit drives one LED partition in the first group of LED partitions in a time-sharing manner with the plurality of groups of first LED drive signals, and drives one LED partition in the second group of LED partitions in a time-sharing manner with the plurality of groups of second LED drive signals.

For example, as shown in FIG. 13, the drive control unit 1302a drives one LED partition in the first group of LED partitions in a time-sharing manner with the plurality of groups of first LED drive signals; the drive control unit 1302b drives one LED partition in the second group of LED partitions in a time-sharing manner with the plurality of groups of second LED drive signals; the drive control unit 1302c drives one of the third group of LED partitions in a time-sharing manner with a plurality of groups of third LED drive signals; and the drive control unit 1302d drives one of the fourth group of LED partitions in a time-sharing manner with a plurality of groups of fourth LED drive signals. Each group of LED drive signals drives the group of LED partitions in a time-sharing manner, and a plurality of LED partitions in the group of LED partitions are distributed in a stepped shape. For a driving process thereof, refer to the description in the foregoing embodiment, and details are not described herein again.

In this embodiment, a plurality of drive control units are used for parallel driving, which is a high-speed LED partition drive mode and is suitable for printing a large-sized image. As shown in FIG. 13, the LED array includes 16 LED partitions, and the LED array divides the 16 LED partitions into four groups. The four drive control units respectively drive four groups of LED partitions, and each drive control unit drives, in a time-sharing manner, one of one group of LED partitions connected to the drive control unit. Therefore, the four drive control units may simultaneously drive one of the four groups of LED partitions, that is, may simultaneously drive four LED partitions in the 16 LED partitions to emit light. This improves a drive speed, and also improves a print speed of an LED printer.

According to an LED print drive method provided in this embodiment of this application, an LED array is divided into a plurality of LED partitions, the plurality of LED partitions are distributed in a staggered manner based on a specified sequence, and different LED partitions are driven, in a time-sharing manner, to emit light, so that fewer driver chips are required, reducing LED printing costs.

A plurality of drive control units are used to drive in parallel. This improves the drive speed and is suitable for printing a large-sized image.

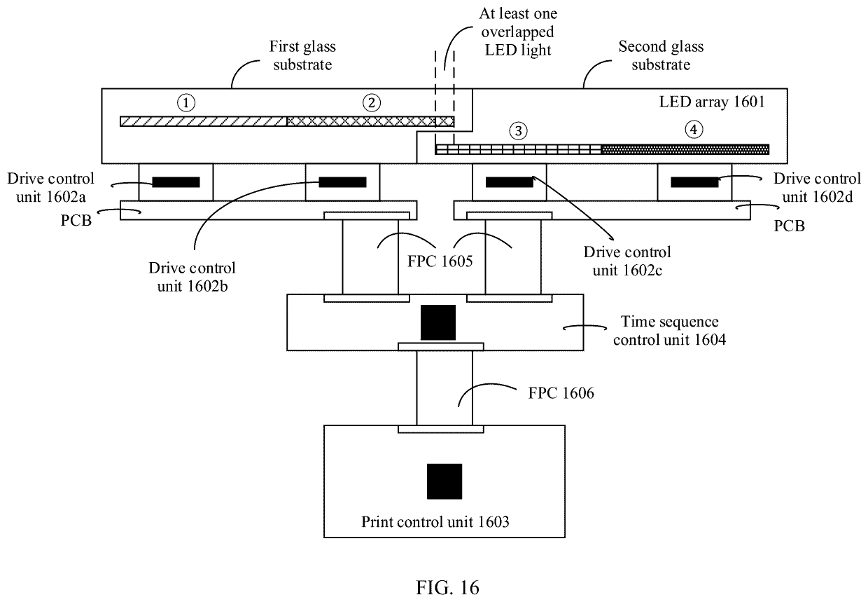

FIG. 16 shows yet another LED print device according to an embodiment of this application. The LED print device includes an LED array 1601 and an LED drive apparatus, where the LED drive apparatus includes a drive control unit 1602a to a drive control unit 1602d, a print control unit 1603, and a time sequence control unit 1604. The LED array 1601 includes a plurality of LED partitions (in FIG. 16, a total of four LED partitions [symbol] to [symbol] are illustrated, and a quantity of LED partitions is not limited in embodiments). Each LED partition includes one or more LED lights. The LED array 1601 is formed on a glass substrate, the glass substrate is in a long strip shape, and the glass substrate in the long strip shape is formed by splicing at least two glass substrates. In FIG. 16, the at least two glass substrates include a first glass substrate and a second glass substrate. The first glass substrate includes a plurality of first LED partitions (in FIG. 16, including the LED partition [symbol] and the LED partition [symbol] ), and the second glass substrate includes a plurality of second LED partitions (in FIG. 16, including the LED partition [symbol] and the LED partition [symbol] . The LED partition [symbol] and the LED partition [symbol] on the first glass substrate are arranged in a straight line, and the LED partition [symbol] and the LED partition [symbol] on the second glass substrate are arranged in a straight line. The LED partition [symbol] and the LED partition [symbol] on the first glass substrate and the LED partition [symbol] and the LED partition [symbol] on the second glass substrate are distributed in a staggered manner based on a specified sequence. For example, the LED partition [symbol] and the LED partition [symbol] on the first glass substrate and the LED partition [symbol] and the LED partition [symbol] on the second glass substrate are in a stepped shape, and steps are parallel to each other. LED lights on adjacent glass substrates overlap with each other.

Each LED partition is driven by a drive control unit. As shown in FIG. 16, the drive control unit 1602a is configured to drive the LED partition [symbol] , the drive control unit 1602b is configured to drive the LED partition [symbol] , the drive control unit 1602c is configured to drive the LED partition [symbol] , and the drive control unit 1602d is configured to drive the LED partition [symbol] . One end of each of the drive control unit 1602a to the drive control unit 1602d is connected to a glass substrate, and the other end is connected to a PCB. The other end of the PCB is connected to the time sequence control unit 1604 through an FPC 1605. The time sequence control unit 1604 is connected to the print control unit 1603 through an FPC 1606.

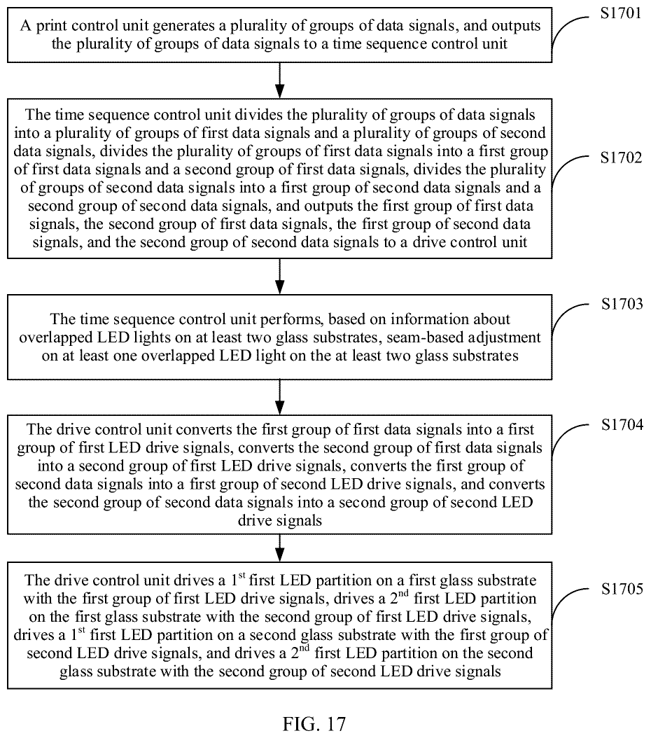

Based on the LED print device shown in FIG. 16, as shown in FIG. 17, an embodiment of this application further provides still yet another LED print drive method. For example, the method includes the following steps.

S1701: A print control unit generates a plurality of groups of data signals, and outputs the plurality of groups of data signals to a time sequence control unit.

As shown in FIG. 16, because the LED array is formed on two glass substrates, and each glass substrate includes two LED partitions, the print control unit outputs two groups of data signals to the time sequence control unit, and each group of data signals corresponds to one glass substrate. For example, the print control unit may simultaneously output two groups of data signals to the time sequence control unit, or the print control unit may sequentially output two groups of data signals to the time sequence control unit.

S1702: The time sequence control unit divides the plurality of groups of data signals into a plurality of groups of first data signals and a plurality of groups of second data signals, divides the plurality of groups of first data signals into a first group of first data signals and a second group of first data signals, divides the plurality of groups of second data signals into a first group of second data signals and a second group of second data signals, and outputs the first group of first data signals, the second group of first data signals, the first group of second data signals, and the second group of second data signals to a drive control unit.

As shown in FIG. 16, the first glass substrate includes a plurality of first LED partitions (in FIG. 16, including the LED partition [symbol] and the LED partition [symbol] ), and the second glass substrate includes a plurality of second LED partitions (in FIG. 16, including the LED partition [symbol] and the LED partition [symbol] ). The LED partition [symbol] and the LED partition [symbol] on the first glass substrate are arranged in a straight line, and the LED partition [symbol] and the LED partition [symbol] on the second glass substrate are also arranged in a straight line. The LED partition [symbol] and the LED partition [symbol] on the first glass substrate and the LED partition [symbol] and the LED partition [symbol] on the second glass substrate are in a stepped shape, and steps are parallel to each other. The LED array in this embodiment is formed on the two glass substrates. It is assumed that the LED array may have N defective pixels, the LED partition on each glass substrate has only N/2 defective pixels. This improves a yield rate of the LED partition.

For example, as shown in FIG. 16, the time sequence control unit 1604 divides the plurality of groups of data signals into a plurality of groups of first data signals and a plurality of groups of second data signals, divides the plurality of groups of first data signals into a first group of first data signals and a second group of first data signals, and divides the plurality of groups of second data signals into a first group of second data signals and a second group of second data signals. Because the LED partition [symbol] and the LED partition [symbol] on the first glass substrate are arranged in a straight line, a time sequence of the first group of first data signals is the same as a time sequence of the second group of first data signals. Because the LED partition [symbol] and the LED partition [symbol] on the second glass substrate are also arranged in a straight line, a time sequence of the first group of second data signals is the same as a time sequence of the second group of second data signals. In addition, because the LED partition [symbol] and the LED partition [symbol] on the first glass substrate and the LED partition [symbol] and the LED partition [symbol] on the second glass substrate are in a stepped shape, time sequences of the plurality of groups of first data signals are different from time sequences of the plurality of groups of second data signals.

The time sequence control unit 1604 outputs the first group of first data signals to the drive control unit 1602a, outputs the second group of first data signals to the drive control unit 1602b, outputs the first group of second data signals to the drive control unit 1602c, and outputs the second group of second data signals to the drive control unit 1602d.

S1703: The time sequence control unit performs, based on information about overlapped LED lights on the at least two glass substrates, seam-based adjustment on the at least one overlapped LED light on the at least two glass substrates.

For specific implementation of this step, refer to step S1103 in the embodiment shown in FIG. 11. Details are not described herein again.

S1704: The drive control unit converts the first group of first data signals into a first group of first LED drive signals, converts the second group of first data signals into a second group of first LED drive signals, converts the first group of second data signals into a first group of second LED drive signals, and converts the second group of second data signals into a second group of second LED drive signals.

After receiving the first group of first data signals, the drive control unit 1602a converts the first group of first data signals into a first group of first LED drive signals; after receiving the second group of first data signals, the drive control unit 1602b converts the second group of first data signals into a second group of first LED drive signals; after receiving the first group of second data signals, the drive control unit 1602c converts the first group of second data signals into a first group of second LED drive signals; and after receiving the second group of second data signals, the drive control unit 1602d converts the second group of second data signals into a second group of second LED drive signals.

S1705: The drive control unit drives a 1st first LED partition on the first glass substrate with the first group of first LED drive signals, drives a 2nd first LED partition on the first glass substrate with the second group of first LED drive signals, drives a 1st first LED partition on the second glass substrate with the first group of second LED drive signals, and drives a 2nd first LED partition on the second glass substrate with the second group of second LED drive signals.

The drive control unit 1602a drives the LED partition [symbol] with the first group of first LED drive signals; the drive control unit 1602b drives the LED partition [symbol] with the second group of first LED drive signals; the drive control unit 1602c drives the LED partition [symbol] with the first group of second LED drive signals; and the drive control unit 1602d drives the LED partition [symbol] with the second group of second LED drive signals. A time sequence of the first group of first LED drive signals is the same as a time sequence of the second group of first LED drive signals, that is, the first group of first LED drive signals and the second group of first LED drive signals drive the LED partition [symbol] and the LED partition [symbol] simultaneously; and a time sequence of the first group of second LED drive signals is the same as a time sequence of the second group of second LED drive signals, that is, the first group of second LED drive signals and the second group of second LED drive signals drive the LED partition [symbol] and the LED partition [symbol] simultaneously. In addition, the first group of first LED drive signals and the second group of first LED drive signals, and the first group of second LED drive signals and the second group of second LED drive signals perform driving in a time-sharing manner.

In this embodiment, a plurality of drive control units are used for parallel driving, which is a high-speed LED partition drive mode and is suitable for printing a large-sized image. As shown in FIG. 16, the drive control unit 1602a and the drive control unit 1602b drive the LED partition [symbol] and the LED partition [symbol] at the same time respectively; and the drive control unit 1602c and the drive control unit 1602d drive the LED partition [symbol] and the LED partition [symbol] at the same time respectively.

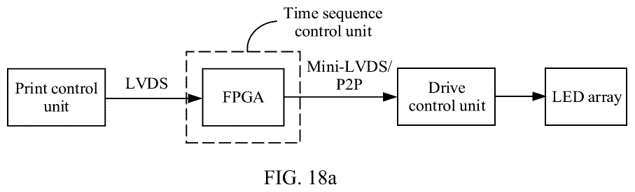

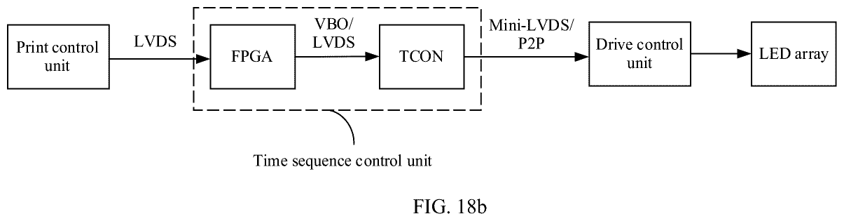

FIG. 18a is a diagram of a structure of a time sequence control unit according to an embodiment of this application. The time sequence control unit is configured to implement a data processing function, for example, bit conversion, data latching, serial-to-parallel conversion, brightness uniformity compensation, temperature compensation, mapping, or line buffer, and a time sequence control function. The time sequence control unit may be implemented by using an FPGA chip/a TCON chip. A drive control unit only implements a function of generating a drive signal, and may use an existing drive control chip, without changing an internal function and a structure of the drive control chip.

FIG. 18b is a diagram of a structure of another time sequence control unit according to an embodiment of this application. The time sequence control unit is configured to implement a data processing function, for example, bit conversion, data latching, serial-to-parallel conversion, brightness uniformity compensation, temperature compensation, mapping, or line buffer, and a time sequence control function. The time sequence control unit includes the FPGA chip and TCON chip. The FPGA chip is configured to implement the foregoing data processing function. The TCON chip is configured to implement the foregoing time sequence control function, and may be implemented by using an existing time sequence control chip. A drive control unit only implements a function of generating a drive signal, and may use an existing drive control chip, without changing an internal function and a structure of the drive control chip.

According to an LED print drive method provided in this embodiment of this application, an LED array is divided into a plurality of LED partitions, the plurality of LED partitions are distributed in a staggered manner based on a specified sequence, and different LED partitions are driven, in a time-sharing manner, to emit light, so that fewer driver chips are required, reducing LED printing costs.

Compared with a conventional silicon-based semiconductor process, a TFT process and a glass substrate technology are used to manufacture the LED array, which greatly reduces costs.

The LED array is formed on the spliced glass substrate. This improves a yield rate of the LED partition.

A plurality of drive control units are used to drive in parallel. This improves the drive speed and is suitable for printing a large-sized image.

Based on a same concept as the foregoing LED print drive method, an embodiment of this application further provides an LED print drive apparatus. It can be understood that, to implement functions in the foregoing embodiments, the LED print drive apparatus includes corresponding hardware structures and/or software modules for performing the functions. A person skilled in the art should be easily aware that, in this application, the units and method steps in the examples described with reference to embodiments disclosed in this application can be implemented by hardware or a combination of hardware and computer software. Whether a function is performed by hardware or hardware driven by computer software depends on particular application scenarios and design constraint conditions of the technical solutions.

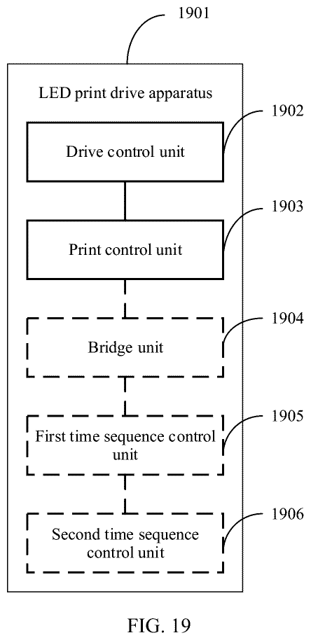

FIG. 19 is a diagram of a structure of still yet another LED print drive apparatus according to an embodiment of this application. The apparatus 1901 includes: a drive control unit 1902 and a print control unit 1903, where the LED array includes a plurality of LED partitions, each LED partition includes one or more LED lights, and the plurality of LED partitions are distributed in a staggered manner based on a specified sequence. The print control unit 1903 is configured to: generate a plurality of groups of data signals, and output the plurality of groups of data signals to the drive control unit 1902. T the drive control unit 1902 is further configured to convert the plurality of groups of data signals into a plurality of groups of LED drive signals. The drive control unit 1902 is further configured to drive, in a time-sharing manner with the plurality of groups of LED drive signals, a corresponding LED partition to emit light, where light-emitting time of each LED partition corresponds to distribution of each LED partition.

Optionally, the LED array is formed on a glass substrate.

Optionally, the plurality of LED partitions are sequentially distributed in a stepped shape or a wave shape.

Optionally, a distance between two adjacent LED partitions is a product of a print speed and a light-emitting time interval between the two LED partitions.

Optionally, the LED array is formed on at least two glass substrates that are spliced with each other, the at least two glass substrates include a first glass substrate and a second glass substrate, the first glass substrate includes a plurality of first LED partitions, the second glass substrate includes a plurality of second LED partitions, and the plurality of first LED partitions and the plurality of second LED partitions are distributed in a stepped shape. The apparatus further includes a bridge unit 1904 (represented by dashed lines in the figure). The bridge unit 1904 is configured to: divide the plurality of groups of data signals into a plurality of groups of first data signals and a plurality of groups of second data signals, and output the plurality of groups of first data signals and the plurality of groups of second data signals to the drive control unit. The drive control unit 1902 is further configured to: convert the plurality of groups of first data signals into a plurality of groups of first LED drive signals, and convert the plurality of groups of second data signals into a plurality of groups of second LED drive signals, where the plurality of groups of first LED drive signals and the plurality of groups of second LED drive signals include a plurality of pairs of LED drive signals of a same time sequence. The drive control unit 1902 is further configured to drive a corresponding first LED partition in a time-sharing manner with the plurality of groups of first LED drive signals. The drive control unit 1902 is further configured to drive a corresponding second LED partition in a time-sharing manner with the plurality of groups of second LED drive signals.

Optionally, at least one LED light on one of the at least two adjacent glass substrates overlaps with at least one LED light on another one of the at least two adjacent glass substrates; and the bridge unit 1904 is further configured to perform, based on information about overlapped LED lights on the at least two glass substrates, seam-based adjustment on the at least one overlapped LED light on the at least two glass substrates.

Optionally, the LED array includes at least two groups of LED partitions, where the at least two groups of LED partitions include a first group of LED partitions and a second group of LED partitions, each group of LED partitions includes one or more LED partitions, each LED partition includes one or more LED lights, and the one or more LED partitions in each group of LED partitions are distributed in a stepped shape. The apparatus further includes a first time sequence control unit 1905 (represented by dashed lines in the figure). The first time sequence control unit 1905 is configured to: divide the plurality of groups of data signals into a plurality of groups of first data signals and a plurality of groups of second data signals, and output the plurality of groups of first data signals and the plurality of groups of second data signals to the drive control unit 1902, where the plurality of groups of first data signals and the plurality of groups of second data signals include a plurality of pairs of data signals of a same time sequence. The drive control unit 1902 is further configured to: convert the plurality of groups of first data signals into a plurality of groups of first LED drive signals, and convert the plurality of groups of second data signals into a plurality of groups of second LED drive signals. The drive control unit 1902 is further configured to drive one LED partition in the first group of LED partitions in a time-sharing manner with the plurality of groups of first LED drive signals. The drive control unit 1902 is further configured to drive one LED partition in the second group of LED partitions in a time-sharing manner with the plurality of groups of second LED drive signals.

Optionally, the LED array is formed on at least two glass substrates that are spliced with each other, the at least two glass substrates include a first glass substrate and a second glass substrate, the first glass substrate includes a plurality of first LED partitions, the second glass substrate includes a plurality of second LED partitions, the plurality of first LED partitions and the plurality of second LED partitions are arranged in a straight line, and the plurality of first LED partitions and the plurality of second LED partitions are distributed in a stepped shape The apparatus further includes a second time sequence control unit 1906 (represented by dashed lines in the figure). The second time sequence control unit 1906 is configured to: divide the plurality of groups of data signals into a plurality of groups of first data signals and a plurality of groups of second data signals, divide the plurality of groups of first data signals into a first group of first data signals and a second group of first data signals, divide the plurality of groups of second data signals into a first group of second data signals and a second group of second data signals, and output the first group of first data signals, the second group of first data signals, the first group of second data signals, and the second group of second data signals to the drive control unit 1902, where a time sequence of the first group of first data signals is the same as a time sequence of the second group of first data signals, a time sequence of the first group of second data signals is the same as a time sequence of the second group of second data signals, and time sequences of the plurality of groups of first data signals are different from time sequences of the plurality of groups of second data signals. The drive control unit 1902 is further configured to: convert the first group of first data signals into a first group of first LED drive signals, convert the second group of first data signals into a second group of first LED drive signals, convert the first group of second data signals into a first group of second LED drive signals, and convert the second group of second data signals into a second group of second LED drive signals. The drive control unit 1902 is further configured to: drive a 1^{st} first LED partition on the first glass substrate with the first group of first LED drive signals, drive a 2^{nd} first LED partition on the first glass substrate with the second group of first LED drive signals, drive a 1^{st} first LED partition on the second glass substrate with the first group of second LED drive signals, and drive a 2^{nd} first LED partition on the second glass substrate with the second group of second LED drive signals.

Optionally, the drive control unit 1902 is further configured to convert a plurality of groups of data signals of a first quantity of bits into a plurality of groups of LED drive signals of a second quantity of bits, where the second quantity is greater than the first quantity.

Optionally, the drive control unit 1902 is further configured to perform brightness uniformity compensation and/or light intensity compensation on the plurality of groups of LED drive signals.

According to an LED print drive apparatus provided in this embodiment of this application, an LED array is divided into a plurality of LED partitions, the plurality of LED partitions are distributed in a staggered manner based on a specified sequence, and different LED partitions are driven, in a time-sharing manner, to emit light, so that fewer driver chips are required, reducing LED printing costs.

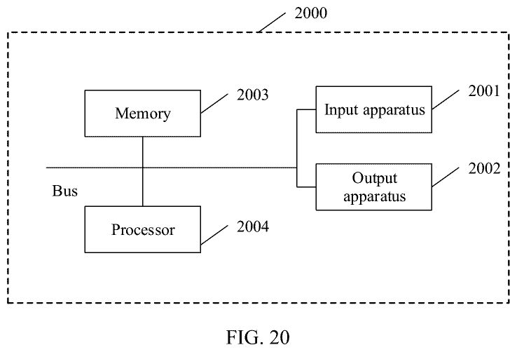

FIG. 20 is a diagram of a structure of a further LED print drive apparatus according to an embodiment of this application. An apparatus 2000 includes an input apparatus 2001, an output apparatus 2002, a memory 2003, and a processor 2004, there may be one or more processors 2004 in the apparatus, and one processor is used as an example in FIG. 20. In some embodiments of this application, the input apparatus 2001, the output apparatus 2002, the memory 2003, and the processor 2004 may be connected through a bus or in another manner. Connection through the bus is used as an example in FIG. 20.

The apparatus 2000 is configured to perform driving control on an LED array. The LED array includes a plurality of LED partitions, each LED partition includes one or more

LED lights, and the plurality of LED partitions are distributed in a staggered manner based on a specified sequence.

The processor 2004 is configured to perform the following steps:
obtaining a plurality of groups of data signals;
converting the plurality of groups of data signals into a plurality of groups of LED drive signals; and
driving, in a time-sharing manner with the plurality of groups of LED drive signals, a corresponding LED partition to emit light, where light-emitting time of each LED partition corresponds to a step in which each LED partition is located.

In a possible implementation, the LED array is formed on a glass substrate.

In another possible implementation, the plurality of LED partitions are sequentially distributed in a stepped shape or a wave shape.

In still another possible implementation, a distance between two adjacent LED partitions is a product of a print speed and a light-emitting time interval between the two LED partitions.

In yet another possible implementation, the LED array is formed on at least two glass substrates that are spliced with each other, the at least two glass substrates include a first glass substrate and a second glass substrate, the first glass substrate includes a plurality of first LED partitions, the second glass substrate includes a plurality of second LED partitions, and the plurality of first LED partitions and the plurality of second LED partitions are distributed in a stepped shape; and the processor 2004 is further configured to perform the following steps:
dividing the plurality of groups of data signals into a plurality of groups of first data signals and a plurality of groups of second data signals;
converting the plurality of groups of first data signals into a plurality of groups of first LED drive signals, and converting the plurality of groups of second data signals into a plurality of groups of second LED drive signals, where the plurality of groups of first LED drive signals and the plurality of groups of second LED drive signals include a plurality of pairs of LED drive signals of a same time sequence; and
driving a corresponding first LED partition in a time-sharing manner with the plurality of groups of first LED drive signals; and driving a corresponding second LED partition in a time-sharing manner with the plurality of groups of second LED drive signals.

In still yet another possible implementation, at least one LED light on one of the at least two adjacent glass substrates overlaps with at least one LED light on another one of the at least two adjacent glass substrates, and the processor 2004 is further configured to perform the following steps:
performing, based on information about overlapped LED lights on the at least two glass substrates, seam-based adjustment on the at least one overlapped LED light on the at least two glass substrates.

In a further possible implementation, the LED array includes at least two groups of LED partitions, where the at least two groups of LED partitions include a first group of LED partitions and a second group of LED partitions, each group of LED partitions includes one or more LED partitions, each LED partition includes one or more LED lights, and the one or more LED partitions in each group of LED partitions are distributed in a stepped shape; and the processor 2004 is configured to perform the following steps:
dividing the plurality of groups of data signals into a plurality of groups of first data signals and a plurality of groups of second data signals, where the plurality of groups of first data signals and the plurality of groups of second data signals include a plurality of pairs of data signals of a same time sequence;
converting the plurality of groups of first data signals into a plurality of groups of first LED drive signals, and converting the plurality of groups of second data signals into a plurality of groups of second LED drive signals;
driving one LED partition in the first group of LED partitions in a time-sharing manner with the plurality of groups of first LED drive signals; and
driving one LED partition in the second group of LED partitions in a time-sharing manner with the plurality of groups of second LED drive signals.

In a still further possible implementation, the LED array is formed on at least two glass substrates that are spliced with each other, the at least two glass substrates include a first glass substrate and a second glass substrate, the first glass substrate includes a plurality of first LED partitions, the second glass substrate includes a plurality of second LED partitions, the plurality of first LED partitions and the plurality of second LED partitions are arranged in a straight line, and the plurality of first LED partitions and the plurality of second LED partitions are distributed in a stepped shape; and the processor 2004 is configured to perform the following steps:
dividing the plurality of groups of data signals into a plurality of groups of first data signals and a plurality of groups of second data signals, dividing the plurality of groups of first data signals into a first group of first data signals and a second group of first data signals, and dividing the plurality of groups of second data signals into a first group of second data signals and a second group of second data signals, where a time sequence of the first group of first data signals is the same as a time sequence of the second group of first data signals, a time sequence of the first group of second data signals is the same as a time sequence of the second group of second data signals, and time sequences of the plurality of groups of first data signals are different from time sequences of the plurality of groups of second data signals;
converting the first group of first data signals into a first group of first LED drive signals, converting the second group of first data signals into a second group of first LED drive signals, converting the first group of second data signals into a first group of second LED drive signals, and converting the second group of second data signals into a second group of second LED drive signals; and
driving a 1^{st} first LED partition on the first glass substrate with the first group of first LED drive signals, driving a 2^{nd} first LED partition on the first glass substrate with the second group of first LED drive signals, driving a 1^{st} first LED partition on the second glass substrate with the first group of second LED drive signals, and driving a 2^{nd} first LED partition on the second glass substrate with the second group of second LED drive signals.

In a yet further possible implementation, the processor 2004 is further configured to perform the following steps:
converting a plurality of groups of data signals of a first quantity of bits into a plurality of groups of LED drive signals of a second quantity of bits, where the second quantity is greater than the first quantity.

In a still yet further possible implementation, before the processor 2004 performs the step of driving, in a time-sharing manner with the plurality of groups of LED drive signals, a corresponding LED partition to emit light, the processor 2004 is configured to perform the following steps:
performing brightness uniformity compensation and/or light intensity compensation on the plurality of groups of LED drive signals.

It may be understood that functions of function modules in the apparatus 2000 in this embodiment may be specifically implemented according to the methods in the foregoing method embodiments. For a specific implementation process, refer to related descriptions of the foregoing method embodiments, and details are not described herein again.

According to an LED print drive apparatus provided in this embodiment of this application, an LED array is divided into a plurality of LED partitions, the plurality of LED partitions are distributed in a staggered manner based on a specified sequence, and different LED partitions are driven, in a time-sharing manner, to emit light, so that fewer driver chips are required, reducing LED printing costs.

An embodiment of this application further provides a computer-readable storage medium. The computer-readable storage medium stores a computer program or instructions. When the program or the instructions are executed by a processor, the method in the foregoing embodiment is performed.

An embodiment of this application further provides a computer program product. When the computer program product is executed on a calculating device, the method in the foregoing embodiment is performed.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In several embodiments provided in this application, it should be understood that the disclosed system, apparatus, and method may be implemented in other manners. For example, division into the units is only logical function division and may be another division in actual implementation. For example, a plurality of units or assemblies may be combined or integrated into another system, or some features may be ignored or not performed. The displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, in other words, may be located in one position, or may be distributed on a plurality of network units. Some or all of the units may be selected based on actual requirements to achieve the objectives of the solutions of embodiments.

All or some of the foregoing embodiments may be implemented by using software, hardware, firmware, or any combination thereof. When software is used to implement the embodiments, all or some of the embodiments may be implemented in a form of a computer program product. The computer program product includes one or more computer instructions. When the computer program instructions are loaded and executed on a computer, the procedures or functions according to embodiments of this application are all or partially generated. The computer may be a general-purpose computer, a dedicated computer, a computer network, or other programmable apparatuses. The computer instructions may be stored in a computer-readable storage medium, or transmitted by using the computer-readable storage medium. The computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device, for example, a server or a data center, integrating one or more usable media. The usable medium may be a read-only memory (ROM), a random access memory (RAM), or a magnetic medium, for example, a floppy disk, a hard disk, a magnetic tape, a magnetic disk, or an optical medium, for example, a digital versatile disc (DVD), or a semiconductor medium, for example, a solid state disk (SSD).

What is claimed is:

1. An LED print drive method, wherein the method is used to drive an LED array, which comprises a plurality of LED partitions, each LED partition comprises one or more LED lights, and the plurality of LED partitions are distributed in a staggered manner based on a specified sequence; and the method comprises:
obtaining a plurality of groups of data signals;
converting the plurality of groups of data signals into a plurality of groups of LED drive signals; and
driving, in a time-sharing manner with the plurality of groups of LED drive signals, an associated LED partition to emit light, wherein light-emitting time of each LED partition is associated with distribution of each LED partition.

2. The method according to claim 1, wherein the converting the plurality of groups of data signals into the plurality of groups of LED drive signals comprises:
converting a plurality of groups of data signals of a first quantity of bits into a plurality of groups of LED drive signals of a second quantity of bits, wherein the second quantity is greater than the first quantity.

3. The method according to claim 1, wherein before the driving, in the time-sharing manner with the plurality of groups of LED drive signals, the associated LED partition to emit light, the method further comprises:
performing brightness uniformity compensation and/or light intensity compensation on the plurality of groups of LED drive signals.

4. An LED print drive apparatus, wherein the apparatus is located in an LED print device, the LED print device further comprises an LED array, which comprises a plurality of LED partitions, each LED partition comprises one or more LED lights, and the plurality of LED partitions are distributed in a staggered manner based on a specified sequence; and the apparatus comprises:
a processor; and
a memory coupled to the processor, storing instructions, which are configured to run by the processor;
wherein the processor is configured to run the instructions and is caused to implement the following:
generating a plurality of groups of data signals, and output the plurality of groups of data signals; and
converting the plurality of groups of data signals into a plurality of groups of LED drive signals, and driving, in a time-sharing manner with the plurality of groups of LED drive signals, an associated LED partition to emit light, wherein light-emitting time of each LED partition is associated with distribution of each LED partition.

5. The apparatus according to claim 4, wherein a distance between two adjacent LED partitions is a product of a print speed and a light-emitting time interval between the two LED partitions.

6. The apparatus according to claim 4, wherein the LED array is formed on at least two glass substrates that are spliced with each other, the at least two glass substrates comprise a first glass substrate and a second glass substrate, the first glass substrate comprises a plurality of first LED partitions, the second glass substrate comprises a plurality of second LED partitions, and the plurality of first LED partitions and the plurality of second LED partitions are distributed in a stepped shape; and the processor is further configured to:
divide the plurality of groups of data signals into a plurality of groups of first data signals and a plurality of groups of second data signals, and output the plurality of groups of first data signals and the plurality of groups of second data signals;
convert the plurality of groups of first data signals into a plurality of groups of first LED drive signals, and convert the plurality of groups of second data signals into a plurality of groups of second LED drive signals, wherein the plurality of groups of first LED drive signals and the plurality of groups of second LED drive signals comprise a plurality of pairs of LED drive signals of a same time sequence;
drive an associated first LED partition in a time-sharing manner with the plurality of groups of first LED drive signals; and
an associated second LED partition in a time-sharing manner with the plurality of groups of second LED drive signals.

7. The apparatus according to claim 6, wherein at least one LED light on one of the at least two adjacent glass substrates overlaps with at least one LED light on another one of the at least two adjacent glass substrates; and
the processor is further configured to perform, based on information about overlapped LED lights on the at least two glass substrates, seam-based adjustment on the at least one overlapped LED light on the at least two glass substrates.

8. The apparatus according to claim 4, wherein the LED array comprises at least two groups of LED partitions, wherein the at least two groups of LED partitions comprise a first group of LED partitions and a second group of LED partitions, each group of LED partitions comprises one or more LED partitions, each LED partition comprises one or more LED lights, and the one or more LED partitions in each group of LED partitions are distributed in a stepped shape; and the processor is further configured to:
divide the plurality of groups of data signals into a plurality of groups of first data signals and a plurality of groups of second data signals, and output the plurality of groups of first data signals and the plurality of groups of second data signals, wherein the plurality of groups of first data signals and the plurality of groups of second data signals comprise a plurality of pairs of data signals of a same time sequence;
convert the plurality of groups of first data signals into a plurality of groups of first LED drive signals, and convert the plurality of groups of second data signals into a plurality of groups of second LED drive signals;
drive one LED partition in the first group of LED partitions in a time-sharing manner with the plurality of groups of first LED drive signals; and
drive one LED partition in the second group of LED partitions in a time-sharing manner with the plurality of groups of second LED drive signals.

9. The apparatus according to claim 4, wherein the LED array is formed on at least two glass substrates that are spliced with each other, the at least two glass substrates comprise a first glass substrate and a second glass substrate, the first glass substrate comprises a plurality of first LED partitions, the second glass substrate comprises a plurality of second LED partitions, the plurality of first LED partitions and the plurality of second LED partitions are arranged in a straight line, and the plurality of first LED partitions and the plurality of second LED partitions are distributed in a stepped shape; and the processor is further configured to:
divide the plurality of groups of data signals into a plurality of groups of first data signals and a plurality of groups of second data signals, divide the plurality of groups of first data signals into a first group of first data signals and a second group of first data signals, divide the plurality of groups of second data signals into a first group of second data signals and a second group of second data signals, and output the first group of first data signals, the second group of first data signals, the first group of second data signals, and the second group of second data signals, wherein a time sequence of the first group of first data signals is the same as a time sequence of the second group of first data signals, a time sequence of the first group of second data signals is the same as a time sequence of the second group of second data signals, and time sequences of the plurality of groups of first data signals are different from time sequences of the plurality of groups of second data signals;
convert the first group of first data signals into a first group of first LED drive signals, convert the second group of first data signals into a second group of first LED drive signals, convert the first group of second data signals into a first group of second LED drive signals, and convert the second group of second data signals into a second group of second LED drive signals; and
drive a 1^{st} first LED partition on the first glass substrate with the first group of first LED drive signals, drive a 2^{nd} first LED partition on the first glass substrate with the second group of first LED drive signals, drive a 1^{st} first LED partition on the second glass substrate with the first group of second LED drive signals, and drive a 2^{nd} first LED partition on the second glass substrate with the second group of second LED drive signals.

10. The apparatus according to claim 4, wherein the processor is further configured to convert a plurality of groups of data signals of a first quantity of bits into a plurality of groups of LED drive signals of a second quantity of bits, wherein the second quantity is greater than the first quantity.

11. The apparatus according to claim 4, wherein the processor is further configured to perform brightness uniformity compensation and/or light intensity compensation on the plurality of groups of LED drive signals.

12. The apparatus according to claim 4, further comprising:
an input apparatus; and
an output apparatus.

13. An LED print device, comprising:
an LED array, comprises a plurality of LED partitions, each LED partition comprises one or more LED lights, and the plurality of LED partitions are distributed in a staggered manner based on a specified sequence; and
an LED print drive apparatus, located in an LED print device, the LED print drive apparatus comprises:
a processor; and
a memory coupled to the processor, storing instructions, which are configured to run by the processor;
wherein the processor is configured to run the instructions and is caused to implement the following:
generating a plurality of groups of data signals, and output the plurality of groups of data signals; and
converting the plurality of groups of data signals into a plurality of groups of LED drive signals, and driving, in a time-sharing manner with the plurality of groups of LED drive signals, an associated LED partition to emit light, wherein light-emitting time of each LED partition is associated with distribution of each LED partition.

14. The device according to claim 13, wherein the plurality of LED partitions are distributed in a stepped shape.

15. The device according to claim 13, wherein the LED array is formed on a glass substrate.

16. The device according to claim 13, wherein a distance between two adjacent LED partitions is a product of a print speed and a light-emitting time interval between the two LED partitions.

17. The device according to claim 13, wherein the LED array is formed on at least two glass substrates that are spliced with each other, the at least two glass substrates comprise a first glass substrate and a second glass substrate, the first glass substrate comprises a plurality of first LED partitions, the second glass substrate comprises a plurality of second LED partitions, and the plurality of first LED partitions and the plurality of second LED partitions are distributed in a stepped shape.

18. The device according to claim 17, wherein at least one LED light on one of the at least two adjacent glass substrates overlaps with at least one LED light on another one of the at least two adjacent glass substrates.

19. The device according to claim 13, wherein the LED array comprises at least two groups of LED partitions, wherein the at least two groups of LED partitions comprise a first group of LED partitions and a second group of LED partitions, each group of LED partitions comprises one or more LED partitions, each LED partition comprises one or more LED lights, and the one or more LED partitions in each group of LED partitions are distributed in a stepped shape.

20. The device according to claim 13, wherein the LED array is formed on at least two glass substrates that are spliced with each other, the at least two glass substrates comprise a first glass substrate and a second glass substrate, the first glass substrate comprises a plurality of first LED partitions, the second glass substrate comprises a plurality of second LED partitions, the plurality of first LED partitions and the plurality of second LED partitions are arranged in a straight line, and the plurality of first LED partitions and the plurality of second LED partitions are distributed in a stepped shape.
